(19) United States
(12) Patent Application Publication
(10) Pub. No.: US 2026/0288570 A1
(43) Pub. Date: Sep. 24, 2026

(54) AI REFLEX ENGINE FOR AUTOMATED POLICY CHANGE INTERVENTION

(71) Applicant: PolicyEdge AI LLC, Gambrills, MD (US)

(72) Inventor: Christina Heintze Witmer, Gambrills, MD (US)

(21) Appl. No.: 19/263,803

(22) Filed: Jul. 9, 2025

Related U.S. Application Data
(60) Provisional application No. 63/834,391, filed on Mar. 19, 2025.

(51) Int. Cl. G06F 11/07; G06F 40/30

(52) U.S. Cl. CPC G06F 11/0793; G06F 11/0787; G06F 40/30

(57) ABSTRACT

An automated policy-intervention platform configured to transform policy deltas into machine-executed controls. The system ingests first and second versions of a policy document, compares them via a delta-detection engine to produce a delta object, and may assign a risk-weight. A mapping engine links the delta to affected targets and outputs a context vector describing operational impact. A reflex logic core executed by a large-language-model inference service uses the delta object and context vector to specify a remedial control action, its triggering condition, and an authorized actor, while suppressing execution when a computed reflex score is below a threshold. An orchestration module programmatically executes the remedial control action on the affected targets and, upon failure, triggers a fallback action. All artifacts, including delta object, context vector, remedial or fallback actions, and reasoning trace, are immutably recorded in an audit ledger, and an interface renders a reflex graph for transparent compliance oversight.

### CROSS-REFERENCE TO RELATED APPLICATIONS

This application claims the benefit of U.S. Provisional Application Ser. No. 63/834,391, filed on Mar. 19, 2025; the disclosure of which is hereby incorporated in its entirety at least by reference.

### FIELD

The present disclosure relates to the field of automated governance, risk, and compliance technologies; in particular, computer-implemented methods, systems, and non-transitory computer-readable media for detecting semantic changes in policy documents, mapping those changes to affected computing assets or workflows, and automatically executing context-specific remedial control actions.

### BACKGROUND

Organizations in highly regulated sectors, such as finance, healthcare, government services, and critical-infrastructure operations, must comply with a growing body of external mandates that include statutes, administrative regulations, industry frameworks, contract clauses, and internal corporate policies. These source documents change frequently and often without advance notice. Conventional governance, risk, and compliance (GRC) platforms typically ingest the latest text, flag high-level updates, and generate dashboards or “to-do” lists. Human analysts must then interpret each change, decide which information systems, workflows, or personnel are affected, draft remediation instructions, secure approvals, script technical controls, and finally document the outcome for audit purposes. This manual, multi-step process is labor-intensive, error-prone, and slow, leaving a persistent gap between the moment a rule changes and the moment the organization can prove compliance.

Rule-authoring tools and static policy engines attempt to reduce the burden by storing machine-readable rule sets. However, these systems generally require experts to encode every logical condition in advance; they do not automatically translate natural-language amendments into executable controls. Likewise, modern artificial-intelligence-based compliance monitors can detect potential violations but still rely on separate ticketing or orchestration layers, and on human decision makers, to close the loop. In addition, the reasoning behind AI-generated recommendations is often opaque, making it difficult for auditors and regulators to verify why a particular action was taken. Traditional logging mechanisms record events but seldom capture the causal path from a specific policy clause through to the remedial control that was ultimately applied.

Through applied effort, ingenuity, and innovation, Applicant has identified a number of deficiencies and problems with automated GRC technologies. Applicant has developed a solution that is embodied by the present invention, which is described in detail below.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

The present disclosure describes an automated policy-intervention platform that transforms raw policy updates into concrete, machine-executed control actions with full auditability. In operation, an ingestion interface acquires a first and a second version of a policy document (e.g., regulatory text, contractual language, or an AI-safety guideline) originating from external feeds such as governmental repositories, standards-body portals, or document-management systems. Upon receipt, a delta-detection engine compares the two versions to isolate each linguistic difference and encapsulates every change in a structured delta object. The delta object may be annotated with a risk-weight value that reflects both impact severity and likelihood.

The delta object is forwarded to a mapping engine that resolves the change into one or more affected targets (for example, a microservice, containerized workload, database schema, or user role) and emits a context vector describing the operational implications of the change. Domain-specific execution packs can also be selected at this stage to supply pre-defined remedial-action templates.

In accordance with certain aspects of the present disclosure, a reflex logic core is implemented as a prompt stack executed by a large-language-model inference service. The reflex logic core is configured to receive the delta object and context vector. In accordance with certain embodiments, the reflex logic core is configured to specify (i) at least one remedial control action, (ii) the condition that triggers that action, and (iii) the authorized actor or system permitted to carry it out. The core may compute a reflex score for each delta object; if the score falls below a configurable threshold, execution is suppressed to avoid unnecessary intervention. A real-time orchestration module then issues programmatic calls to external system interfaces to enact the remedial control action on the affected targets. The orchestration module monitors return statuses continuously; upon detecting a failure, it can autonomously generate and run a fallback remedial action.

Throughout the workflow, an immutable audit ledger stores (a) the delta object, (b) each context vector, (c) the executed remedial action (or its suppression), (d) any fallback action, (e) assigned risk-weights, and (f) the full reasoning trace output by the reflex logic core. A user-interface layer can render a reflex graph that visually links the change, its context, and the resulting control action, thereby providing transparent explainability to compliance officers and other stakeholders.

Certain aspects of the present disclosure provide for a computer-implemented method for automated intervention of policy changes. In accordance with certain aspects of the present disclosure, the method comprises one or more steps or operations for receiving (e.g., by one or more processors) a first version of a policy document and a second version of the policy document. The method may further comprise one or more steps or operations for executing (e.g., by a delta-detection engine) instructions that compare the first version of the policy document and the second version of the policy document to identify at least one linguistic difference and, in response, generate a delta object based on the at least one linguistic difference. The method may further comprise one or more steps or operations for inputting the delta object to a mapping engine to determine one or more affected target and to produce at least one context vector configured to describe an operational impact of the at least one linguistic difference. The method may further comprise one or more steps or operations for providing the delta object and the at least one context vector to a reflex logic core executable by a large language model inference service. In accordance with certain aspects of the present disclosure, the reflex logic core is configured to specify (i) at least one remedial control action, (ii) a condition under which the at least one remedial control action is to be executed, and (iii) an identity of an actor or system authorized to execute the at least one remedial control action. The method may further comprise one or more steps or operations for automatically executing (e.g., by an orchestration module) the remedial control action on the one or more affected target by issuing at least one programmatic call to an external system interface. The method may further comprise one or more steps or operations for recording (e.g., in an audit ledger) (i) the delta object, (ii) the at least one context vector, (iii) the remedial control action, and (iv) a reasoning trace produced by the reflex logic core.

In accordance with certain embodiments, the method may be further configured wherein generating the delta object further comprises assigning a risk-weight value to the delta object based on at least one of an impact-severity metric and a likelihood metric. The method may be further configured wherein the reflex logic core computes a reflex score for the delta object, compares the reflex score to a predefined threshold, and suppresses execution of the remedial control action when the reflex score is below the threshold. In certain embodiments, the method may be further configured wherein the reflex logic core comprises a chain-of-thought prompt stack executable by the large language model inference service. The method may be further configured wherein the context vector comprises a mapping between an originating policy citation and a unique identifier of the one or more affected target selected from the group consisting of: a microservice, a containerized workload, a database schema, and a user role. The method may be further configured wherein the first version of the policy document, and the second version of the policy document are received from an external policy source feed selected from the group consisting of: a governmental regulation repository, a contractual document-management system, a standards-body publication portal, and an artificial intelligence safety policy registry. In accordance with certain embodiments, the method may further comprise one or more steps or operations for selecting (e.g., based on the at least one context vector) a domain-specific execution pack that supplies a predefined remedial control action template to the orchestration module. In accordance with certain embodiments, the method may further comprise one or more steps or operations for rendering (e.g., in a user interface) a reflex graph that visually links the delta object, the at least one context vector, and the executed remedial control action. The method may be further configured wherein the orchestration module is configured to monitor (e.g., in real time) a status returned from the external system interface. The method may be further configured wherein the orchestration module is configured to automatically generate and execute a fallback remedial control action and record the fallback action in the audit ledger upon detecting a failure status from the external system interface.

Further aspects of the present disclosure provide for an automated policy intervention system comprising an ingestion interface configured to receive a first version of a policy document and a second version of the policy document and a delta-detection engine operatively coupled to the ingestion interface. In accordance with certain embodiments, the delta-detection engine is configured to compare the first version of a policy document and a second version of the policy document to identify at least one linguistic difference and, in response, to generate a delta object based on the at least one linguistic difference. The system may further comprise a mapping engine configured to determine one or more affected target associated with the delta object and to produce at least one context vector configured to describe an operational impact of the at least one linguistic difference. The system may further comprise a reflex logic core comprising a prompt stack stored in a non-transitory memory and a large language model inference service. In certain embodiments, the reflex logic core is configured to specify (i) at least one remedial control action, (ii) a condition under which the at least one remedial control action is to be executed, and (iii) an identity of an actor or system authorized to execute the at least one remedial control action. The system may further comprise an orchestration module communicatively coupled to the reflex logic core. In certain embodiments, the orchestration module is configured to execute the at least one remedial control action on the one or more affected target by issuing at least one programmatic call to an external system interface. The system may further comprise an audit ledger configured to record (i) the delta object, (ii) the at least one context vector, (iii) an identifier of the executed remedial control action, and (iv) a reasoning trace produced by the reflex logic core.

In accordance with certain aspects of the present disclosure, the automated policy intervention system may further comprise a risk-weighting module configured to assign an impact-severity value to the delta object and store the impact-severity value in association with the delta object in the audit ledger. In certain embodiments, the reflex logic core is further configured to compute a reflex score for the delta object, compare the reflex score with a predefined threshold, and suppress execution of the remedial control action when the reflex score is below the threshold. In certain embodiments, the prompt stack comprises a chain-of-thought prompt stack executable by the large language model inference service. In certain embodiments, each context vector comprises a mapping between an originating policy citation and a unique identifier of the one or more affected target selected from the group consisting of: a microservice, a containerized workload, a database schema, and a user role. In certain embodiments, the ingestion interface is configured to receive the first version of the policy document and the second version of the policy document from an external policy-source feed selected from the group consisting of: a governmental regulation repository, a contractual document-management system, a standards-body publication portal, and an artificial intelligence safety policy registry. In certain embodiments, the automated policy intervention system may further comprise a user-interface module configured to render (e.g., in a graphical display) a reflex graph that visually links the delta object, the at least one context vector, and the executed remedial control action. In certain embodiments, the orchestration module is configured to monitor (e.g., in real time) a status returned from the external system interface. In accordance with certain embodiments, the orchestration module is configured to automatically generate and execute a fallback remedial control action and record the fallback action in the audit ledger upon detecting a failure status from the external system interface.

Still further aspects of the present disclosure include a non-transitory computer-readable storage medium encoded with instructions that, when executed by one or more processors of a computing system, cause the computing system to perform one or more operations comprising receiving a first version of a policy document and a second version of the policy document; comparing (e.g., via a delta-detection module) the first version of the policy document and the second version of the policy document to identify at least one linguistic difference and, in response, generating a structured delta object that characterizes the difference; mapping (e.g., via a contextual-mapping module) the delta object to determine one or more affected targets and to produce at least one context vector to describe an operational impact of the at least one linguistic difference; and executing (e.g., by a reflex logic core) a large-language-model inference service to receive the delta object and the context vector. In certain embodiments, the reflex logic core is configured to specify (i) at least one remedial control action, (ii) a condition under which the at least one remedial control action is to be executed, and (iii) an identity of an actor or a system authorized to execute the at least one remedial control action. The operations may further comprise operations for invoking (e.g., via an orchestration module) the at least one remedial control action on the one or more affected target by issuing at least one programmatic call to an external system interface. The operations may further comprise operations for recording (e.g., in an audit ledger) (i) the delta object, (ii) the at least one context vector, (iii) the remedial control action, and (iv) a reasoning trace produced by the reflex logic core.

The foregoing has outlined rather broadly the more pertinent and important features of the present invention so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present invention. It should be realized by those skilled in the art that such equivalent structures do not depart from the spirit and scope of the invention as set forth in the appended claims.

### BRIEF DESCRIPTION OF DRAWINGS

The skilled artisan will understand that the figures, described herein, are for illustration purposes only. It is to be understood that in some instances various aspects of the described implementations may be shown exaggerated or enlarged to facilitate an understanding of the described implementations. In the drawings, like reference characters generally refer to like features, functionally similar and/or structurally similar elements throughout the various drawings. The drawings are not necessarily to scale, emphasis instead being placed upon illustrating the principles of the teachings. The drawings are not intended to limit the scope of the present teachings in any way. The systems, methods and computer-readable media may be better understood from the following illustrative description with reference to the following drawings in which:

FIG. 1 is a schematic block diagram of an exemplary automated policy-intervention platform, in accordance with certain aspects of the present disclosure;

FIG. 2 is a data-flow diagram showing the end-to-end compliance workflow executed by the automated policy-intervention platform;

FIG. 3 is a detailed schematic of an exemplary delta object data structure, depicting change tokens, metadata fields, and an optional risk-weight attribute;

FIG. 4 is a flowchart illustrating operations performed by the contextual-mapping engine to resolve a delta object into affected targets and to emit a context vector with impact descriptors;

FIG. 5 is a logic diagram of the reflex logic core, showing prompt stack stages, reflex-score evaluation, and conditional suppression of remedial actions;

FIG. 6 is a sequence diagram depicting orchestration-module interactions with external systems (e.g., HRIS, EMR, payroll, or identity-management APIs) to execute remedial and fallback control actions;

FIG. 7 is a schematic user-interface rendering of a reflex graph that visually links a policy change to its mapped targets, executed controls, and audit-ledger entry;

FIG. 8 is a workflow diagram exemplifying a use case of the automated policy-intervention platform to monitor healthcare-worker licensing requirements;

FIG. 9 is a workflow diagram exemplifying a use case of the automated policy-intervention platform to monitor banned substances rules for sports teams;

FIG. 10 is a workflow diagram exemplifying a use case of the automated policy-intervention platform to monitor to enforce multi-jurisdiction employment laws for employers;

FIG. 11 is a schematic view of an exemplary context vector showing fields such as delta-ID links, target identifiers, jurisdiction, risk score, optional metadata, and associated timestamps;

FIG. 12 is a five-by-five matrix that classifies risk weight by plotting impact severity against likelihood and shading cells from LOW to CRITICAL according to a legend;

FIG. 13 is a block diagram illustrating modular reflex-pack plug-ins that dock into a core compliance engine through a standardized plug-in API;

FIG. 14 is a flowchart of a process to train a machine learning algorithm, according to some implementations;

FIG. 15 is a block diagram illustrating a representative software architecture, which may be used in conjunction with various hardware architectures herein described; and

FIG. 16 is a block diagram illustrating components of a machine, according to some exemplary embodiments, able to read instructions from a machine-readable medium (e.g., a machine-readable storage medium) and perform any one or more of the methodologies discussed herein.

### DETAILED DESCRIPTION

It should be appreciated that all combinations of the concepts discussed in greater detail below (provided such concepts are not mutually inconsistent) are contemplated as being part of the inventive subject matter disclosed herein. It also should be appreciated that terminology explicitly employed herein that also may appear in any disclosure incorporated by reference should be accorded a meaning most consistent with the particular concepts disclosed herein.

Following below are more detailed descriptions of various concepts related to, and embodiments of, inventive methods, apparatus and systems for an automated policy-intervention platform configured to transform policy deltas into machine-executed controls. Embodiments of the present disclosure are configured to ingest first and second versions of a policy document, compares the versions via a delta-detection engine to produce a delta object and, optionally, assign a risk-weight. A mapping engine links the delta to affected targets and outputs a context vector describing operational impact. A reflex logic core executed by a large-language-model inference service uses the delta object and context vector to specify a remedial control action, its triggering condition, and an authorized actor, while suppressing execution when a computed reflex score is below a threshold. An orchestration module programmatically executes the remedial control action on the affected targets and, upon failure, triggers a fallback action. All artifacts, including delta object, context vector, remedial or fallback actions, and reasoning trace, are immutably recorded in an audit ledger, and an interface renders a reflex graph for transparent compliance oversight.

It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes. The present disclosure should in no way be limited to the exemplary implementation and techniques illustrated in the drawings and described below.

Before the present invention and specific exemplary embodiments of the invention are described, it is to be understood that this invention is not limited to the particular embodiments described, and as such may vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed by the invention. The upper and lower limits of these smaller ranges may independently be included in the smaller ranges, and are also encompassed by the invention, subject to any specifically excluded limit in a stated range. Where a stated range includes one or both of the endpoint limits, ranges excluding either or both of those included endpoints are also included in the scope of the invention.

As used herein, “exemplary” means serving as an example or illustration and does not necessarily denote ideal or best.

As used herein, the term “includes” means includes but is not limited to, the term “including” means including but not limited to. The term “based on” means based at least in part on.

As used herein, the term “interface” refers to any shared boundary across which two or more separate components of a computer system may exchange information. The exchange can be between software, computer hardware, peripheral devices, humans, and combinations thereof.

As used herein, the term “policy document” encompasses any machine-readable or human-readable text that expresses a mandatory or advisory rule, guideline, standard, contractual clause, or regulatory requirement, including without limitation governmental regulations, industry standards, corporate governance policies, service-level agreements, safety policies, ethics codes, and contractual stipulations. The term expressly covers both documents authored internally by an enterprise and documents obtained from external sources such as regulatory repositories or standards bodies.

As used herein, the term “delta object” is a structured data construct that characterizes at least one linguistic difference detected between two versions of a policy document. The construct may include, for example, a token-level diff, semantic annotations, positional metadata, a risk-weight value, and any other machine-interpretable attributes useful for downstream processing.

As used herein, the term “linguistic difference” refers to any addition, deletion, substitution, reordering, or alteration of text, numbers, symbols, or punctuation that changes the meaning, scope, or applicability of a policy document provision.

As used herein, the term “affected target” or “target” is any computable entity (e.g., microservice, containerized workload, database schema, user role, hardware device, or external service) whose configuration, behavior, or permitted operation is governed—directly or indirectly—by at least one provision of the policy document that is implicated by the delta object.

As used herein, the term “context vector” is a machine-readable tuple or array that encodes the relationship between a delta object and one or more affected targets, including but not limited to originating policy citations, semantic categories, risk attributes, dependency metadata, and operational impact indicators.

As used herein, the term “reflex logic core” is a software component, implemented in whole or in part by a large language model (LLM) inference service, that transforms a delta object and its associated context vector(s) into one or more remedial control actions, together with execution conditions and actor or system authorizations.

As used herein, the term “large language model inference service” denotes any cloud-resident, on-premise, or locally hosted service that exposes inference capabilities of a transformer-based or other parameter-rich language model via an application programming interface (API) or callable runtime.

As used herein, the term “remedial control action” is a predefined or dynamically generated command, configuration change, workflow step, code patch, alert, or other operative measure intended to mitigate, satisfy, or otherwise respond to the operational impact identified by a delta object.

As used herein, the term “external system interface” includes any programmatic or message-based conduit, such as a REST endpoint, RPC call, message-queue topic, or command-line invocation, through which the orchestration module communicates with third-party or peripheral systems to implement a remedial control action.

As used herein, the term “orchestration module” is a software component that receives instructions from the reflex logic core and issues programmatic calls to one or more external system interfaces to execute, monitor, and if necessary, roll back remedial control actions.

As used herein, the term “audit ledger” is a tamper-evident data store (which may be blockchain-backed, append-only, or cryptographically hashed) that persistently records delta objects, context vectors, remedial control actions, reasoning traces, timestamps, and other provenance information sufficient to establish a verifiable compliance record.

As used herein, the term “risk-weight value” is a numerical or categorical indicator that quantifies, for a given delta object, an estimated level of operational or compliance risk as a function of one or more risk metrics (e.g., impact-severity and likelihood).

As used herein, the term “impact-severity metric” measures the potential magnitude of adverse effect that a linguistic difference may cause if left unaddressed, such as financial loss, security exposure, or regulatory non-conformance.

As used herein, the term “likelihood metric” estimates the probability that a linguistic difference will manifest as an operational issue under current or projected conditions.

As used herein, the term “reflex score” is an aggregate numerical value produced by the reflex logic core that reflects combined risk, confidence, and impact factors associated with a delta object; the score is compared to a predefined threshold to decide whether to execute or suppress a remedial control action.

As used herein, the term “chain-of-thought prompt stack” is an ordered set of natural-language prompts designed to elicit multi-step reasoning from an LLM, the prompts being assembled dynamically or retrieved from a template repository.

As used herein, the term “domain-specific execution pack” is a curated collection of action templates, parameter schemas, and validation tests tailored to a particular technical or business domain (e.g., container orchestration, data-privacy compliance) and selectable by the orchestration module based on context-vector attributes.

As used herein, the term “reflex graph” is a visual or logical representation that links delta objects, context vectors, and executed remedial control actions via directed edges, enabling users to trace causal relationships and verify intervention outcomes.

An exemplary system, method, and platform according to the principles herein may include a delta-detection engine configured to compare first and second versions of a policy document and emit a structured delta object that captures each substantive linguistic difference.

An exemplary system, method, and platform according to the principles herein may include a risk-weighting module that assigns impact-severity and likelihood scores to every delta object so downstream logic can prioritize high-risk changes.

An exemplary system, method, and platform according to the principles herein may include a contextual-mapping engine that routes each delta object to one or more affected targets, such as microservices, database schemas, or user roles, and generates a context vector describing the operational impact of the change.

An exemplary system, method, and platform according to the principles herein may include a reflex logic core employing a chain-of-thought prompt stack executed by a large-language-model inference service to derive a remedial control action, the condition that triggers it, and the authorized actor or system that must carry it out.

An exemplary system, method, and platform according to the principles herein may include a reflex-score evaluator that suppresses execution when the computed reflex score for a given delta object falls below a configurable compliance threshold.

An exemplary system, method, and platform according to the principles herein may include an orchestration module that automatically invokes the remedial control action by issuing programmatic calls to external system interfaces and, upon detecting a failure status, generates and executes a fallback control action.

An exemplary system, method, and platform according to the principles herein may include an immutable, hash-linked audit ledger that stores the delta object, context vector, remedial or fallback actions, risk metrics, and full reasoning trace to provide regulator-grade, tamper-evident provenance.

An exemplary system, method, and platform according to the principles herein may include a user-interface module that renders a reflex graph visually linking each policy change to its mapped targets and executed controls, thereby offering transparent oversight to compliance officers.

An exemplary system, method, and platform according to the principles herein may include modular domain-specific execution packs that plug into the core engine to enforce vertical rules, such as AI trust firewalls, GDPR retention mandates, or license-spend optimization, without re-authoring underlying logic.

An exemplary system, method, and platform according to the principles herein may include governance and continuity safeguards that support role-based overrides, ethical guardrails, and resilience controls to ensure safe operation of automated policy intervention in high-trust environments.

In accordance with an exemplary use case, embodiments of the present disclosure may be utilized to monitor and enforce licensing compliance for healthcare staff. In accordance with certain exemplary use cases, an automated policy intervention system may continuously ingest state-board regulations, specialty-practice acts, and renewal-deadline bulletins that govern physician, nursing, and allied-health licenses. A delta-detection engine compares each newly issued bulletin or rule revision against the previously stored version to generate a structured delta object whenever a licensing requirement changes; for example, when a state nursing board accelerates continuing-education hour thresholds or introduces a new opioid-management module. The mapping engine then cross-references the delta object against a hospital's credentialing database to pinpoint every practitioner whose license attributes (e.g., state, specialty, expiration date) match the revised rule and encodes that linkage in a context vector that identifies the affected user role and departmental roster. In response, a chain-of-thought reflex logic core evaluates the delta object and context vector to decide whether an automated remedial control action is warranted; such as temporarily revoking operating-room scheduling privileges for surgeons whose licenses will lapse within 30 days or initiating a work unit (e.g., a SERVICENOW task) ordering immediate renewal documentation. If the computed reflex score for a practitioner falls below a predefined compliance threshold, the action is suppressed to avoid false positives; otherwise, an orchestration module issues the requisite API calls to the hospital's credentialing and staffing systems and, if needed, triggers fallback alerts to human compliance officers. All reasoning traces, risk-weight values, and executed (or suppressed) actions are immutably recorded in the audit ledger, and a reflex graph user interface lets oversight teams drill from any rule change to the specific clinician record it affected, providing regulator-grade transparency for Joint Commission and CMS auditors.

In accordance with an exemplary use case, embodiments of the present disclosure may be utilized to monitor and enforce banned substance compliance for professional athletes. In accordance with certain embodiments, a professional sports club subscribes to daily feeds from the World Anti-Doping Agency (WADA), the relevant league office, and its own medical board that list newly banned substances, threshold-level changes, and therapeutic-use-exemption (TUE) revisions. Each incoming bulletin is compared with the previously stored version by the system's semantic delta-detection engine, which emits a normalized delta object describing every substantive wording change, such as the addition of a newly synthesized stimulant or a lower permissible nanogram threshold for an existing hormone. The delta object is then routed through the contextual-mapping engine, which cross-references the team's roster, supplement-declaration logs, and longitudinal biomarker data to generate a context vector that pinpoints each athlete whose current medication, supplement stack, or biological passport is now non-compliant or approaching the new threshold. A chain-of-thought reflex logic core evaluates the delta object and context vector to decide whether immediate action is warranted; for example, automatically scheduling a follow-up blood test, revoking competition clearance until a TUE is filed, or issuing a nutraceutical substitution plan crafted by the club's sports-medicine staff. When the computed reflex score exceeds a configurable risk threshold, an orchestration module fires the appropriate controls: it updates the athlete-management system, sends secure notifications to coaching staff, and logs a mandatory report to the league's anti-doping portal; if any action fails, a fallback routine escalates the issue to the team's compliance officer. Every delta object, context vector, reasoning trace, and executed (or suppressed) control is immutably recorded in the audit ledger, allowing regulators, league officials, and team doctors to replay the full decision chain and verify that each athlete remained within permissible biochemical parameters at every point in time.

In accordance with an exemplary use case, embodiments of the present disclosure may be utilized to monitor and ensure compliance with government laws and regulations, such as employment laws, by corporation. For example, a multi-state employer may deploy embodiments of the platform as a “labor-law reflex pack” that continuously ingests statutes, agency guidance, and case-law digests issued by all 50 state labor departments, the U.S. Department of Labor, and the Equal Employment Opportunity Commission. Whenever a new rule appears in the incoming feed (e.g., such as a higher minimum wage in California, revised overtime thresholds under the Fair Labor Standards Act, or a ban on non-compete agreements in a specific jurisdiction), the semantic delta-detection engine compares the text against the previously stored version to generate a structured delta object capturing each substantive change. The delta object is passed to the contextual-mapping engine, which cross-references internal HRIS records, union-contract clauses, and time-and-attendance logs to build a context vector identifying every employee, pay code, and policy document affected by the new requirement (for example, hourly workers in California earning less than the updated threshold). A risk-weighting module assigns an impact-severity score so that high-risk deltas are prioritized (e.g., such as those carrying statutory penalties or class-action exposure). A chain-of-thought reflex logic core executed by a large-language-model inference service then reasons over the delta object and context vector to specify one or more remedial control actions. Typical actions include, for example, automatically updating payroll system pay-rate tables, generating retroactive wage-adjustment entries, suspending an out-of-compliance bonus plan, or launching a work order task that routes new meal-break rules to frontline managers for acknowledgment. If the computed reflex score for a given delta is below a configurable threshold (for example, a low-impact clerical change) the action is suppressed to avoid noise. An orchestration module issues programmatic API calls to HR, payroll, and scheduling systems to carry out the selected actions; on any failure (for example, a rejected API call from a legacy payroll platform) the module triggers a fallback routine such as escalating to the compliance officer or opening a ticket for manual remediation. All artifacts (e.g., the delta object, context vector, remedial or fallback actions, reflex-score evaluations, and full reasoning trace) are immutably captured in the audit ledger. A reflex graph UI lets auditors drill from each statutory change to the exact employee records and system parameters updated, furnishing regulator-grade proof during Department of Labor wage-and-hour audits or EEOC investigations.

Certain benefits and advantages of the present disclosure include dramatically shortening the lag between a rule change and its operational intervention by automating every detection-to-action step.

Certain benefits and advantages of the present disclosure include prioritizing compliance resources through risk-weighted scoring that surfaces only the most consequential regulatory deltas for immediate remediation.

Certain benefits and advantages of the present disclosure include furnishing regulator-grade, tamper-evident provenance via an immutable audit ledger that records every decision, action, and underlying reasoning trace.

Certain benefits and advantages of the present disclosure include leveraging large-language-model reasoning to generate context-specific control actions, thereby reducing the need for hard-coded rule trees and manual policy mapping.

Certain benefits and advantages of the present disclosure include orchestrating remedial actions across heterogeneous IT, HR, or medical systems through standardized API calls, enabling turnkey deployment in complex environments.

Certain benefits and advantages of the present disclosure include providing a reflex graph UI that links each policy change to its affected assets and executed controls, enhancing transparency for auditors and stakeholders.

Certain benefits and advantages of the present disclosure include enabling domain-specific “reflex packs” that let organizations address new regulatory verticals (e.g., such as labor, licensing, or anti-doping) without rewriting core logic.

Certain benefits and advantages of the present disclosure include lowering operational costs and error rates by eliminating manual document monitoring, data entry, and compliance exception handling.

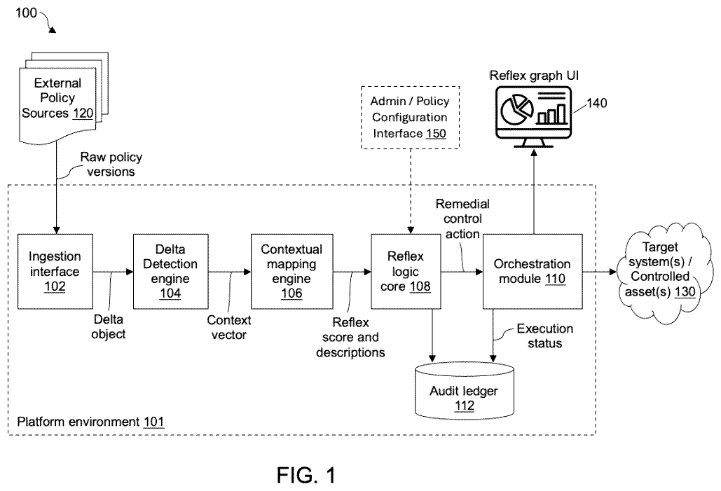

Turning now descriptively to the drawings, in which similar reference characters denote similar elements throughout the several views, FIG. 1 depicts a schematic block diagram of an exemplary automated policy-intervention platform 100 through which certain illustrated embodiments of the present invention may be implemented. In accordance with certain aspects of the present disclosure, a platform environment 101 houses an automated policy-intervention platform 100 that persistently ingests, interprets, and executes policy changes in real time. External Policy Sources 120, such as governmental regulation feeds, contractual repositories, standards-body portals, and AI-safety registries and the like, stream raw policy versions across a secure network boundary to an ingestion interface 102. Ingestion interface 102, which combines API listeners, file-watchers, OCR pipelines, and authentication gateways, receives each incoming version and immediately tags it with provenance metadata before forwarding the text as raw policy versions toward downstream processing.

In accordance with certain aspects of the present disclosure, platform 100 further comprises a delta detection engine 104. In accordance with certain embodiments, delta detection engine 104 performs a semantic diff between successive versions, tokenizing clauses, normalizing citations, and applying natural-language similarity metrics to isolate substantive wording changes. It encapsulates every detected change in a structured delta object that carries a unique change identifier, original and revised tokens, clause locations, and preliminary risk-weight estimates. In accordance with certain aspects of the present disclosure, platform 100 further comprises a contextual-mapping engine 106. In accordance with certain embodiments, contextual-mapping engine 106 consults an internal asset registry, role directory, and jurisdictional taxonomy to correlate the delta object with one or more affected targets (e.g., such as microservices, database schemas, user roles, or physical devices) and emits a richly annotated context vector. In accordance with certain embodiments, the context vector captures target identifiers, jurisdiction tags, impact-severity scores, effective dates, and any execution-template hints needed for remediation.

In accordance with certain aspects of the present disclosure, platform 100 further comprises an asset resilience engine (not shown in FIG. 1) that operates in parallel with the risk-weighting and time-decay components to safeguard the health of critical infrastructure. In accordance with certain embodiments, the asset resilience engine ingests a structured ASSET_ SIGNAL_BUNDLE comprising a composite payload of real-time telemetry, workload statistics, error counters, and, where applicable, environmental or biometric readings. Within the asset resilience engine, a FAILURE_PROBABILITY_MODEL applies statistical or machine-learning techniques to the signal bundle in order to estimate a conditional likelihood of degradation or outright failure for each monitored asset. The asset resilience model continuously updates its estimates as fresh signals arrive, yielding a sliding-window projection of time-to-failure or probability-of-failure that the platform records as a scalar ASSET_FAILURE_FORECAST value. To translate raw probabilities into actionable insight, a LOAD_STRESS_THRESHOLD_ENGINE compares the forecast and supporting metrics against dynamic stress limits, such as CPU saturation, memory pressure, or thermal envelope, and marks any threshold breach with a criticality flag.

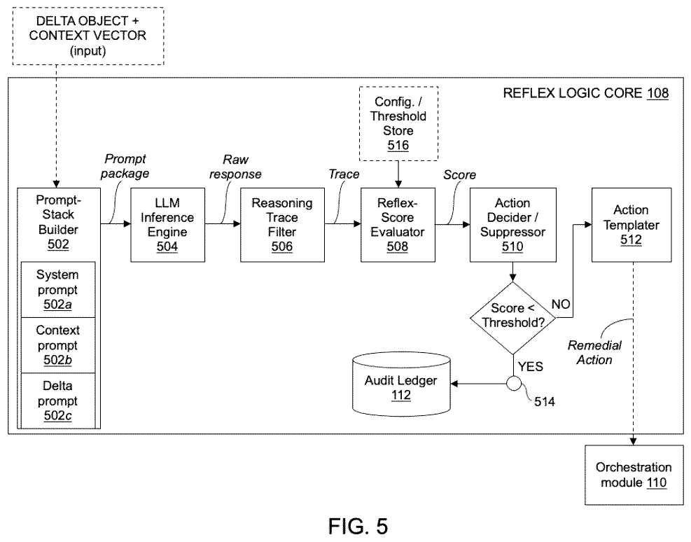

When either the forecast probability exceeds a configurable ceiling or a stress limit is breached, the asset resilience engine emits a high-priority ASSET_FAILURE_FORECAST event that feeds directly into the reflex-score evaluator alongside the static impact-likelihood matrix and the time-decay cost metric. Exceeding the resilience threshold therefore elevates the composite reflex score, prompting action decider 510 (shown in FIG. 5) to orchestrate a preventative control such as workload migration, automated backup, or administrator notification without waiting for an actual outage. Conversely, when mitigation steps reduce stress or the failure probability falls below the floor, the asset resilience engine downgrades the forecast, allowing the same decision logic to deactivate previously scheduled controls and conserve resources.

In accordance with certain aspects of the present disclosure, platform 100 further comprises a reflex logic core 108. In certain embodiments, reflex logic core 108 invokes a large-language-model inference service through a chain-of-thought prompt stack that embeds domain prompts, compliance heuristics, and historical reasoning traces. Using the delta object and context vector, reflex logic core 108 calculates a reflex score, selects an action template, identifies the authorized actor, and assembles a fully specified remedial control action. In accordance with certain embodiments, platform 100 comprises a dealbreaker logic layer. In certain embodiments, the dealbreaker logic layer functions as an inline gatekeeper positioned in the communication path between reflex logic core 108 and the large-language-model inference service. The dealbreaker logic layer may be configured to inspect every outbound prompt before inference and every inbound model response after inference. In certain embodiments, the dealbreaker logic layer applies dynamically configurable freshness, formatting, and policy-compliance rules to prompts, then subjects provisional outputs to content-safety and operational-validity checks, rejecting, rewriting, or approving each item while immutably logging every decision, so that only policy-conforming, context-valid, and safety-vetted instructions can propagate to the orchestration module and beyond. In accordance with certain embodiments, when the reflex score meets or exceeds a configurable threshold, reflex logic core 108 queues the action and pushes a signed execution descriptor to an orchestration module 110. In accordance with certain embodiments, if the score falls below the threshold, reflex logic core 108 records a suppression decision along with its reasoning trace. Orchestration module 110 converts the remedial control action into one or more programmatic calls that target systems or controlled assets 130 can consume (e.g., RESTful API calls, message-bus events, or direct database statements) and continuously monitors the execution status returned from each call. On a failure signal, orchestration module 110 automatically retrieves a fallback template and issues a compensating action without human intervention.

In accordance with certain aspects of the present disclosure, platform 100 further comprises an executable logic construction layer (not shown in FIG. 1) configured to transform abstract policy constructs into verifiable, machine-executable decision graphs. The executable logic construction layer receives as input a fully resolved and context-linked policy artifact, such as a regulatory control, contract clause, or jurisdictional obligation, enriched with metadata by the contextual mapping engine 106. The executable logic construction layer then parses the artifact using a domain-specific modeling language (DSML) to extract key components (e.g., conditions, triggers, exceptions, and prescribed actions) and compiles them into a set of canonical logic templates stored in logic assembly store 520 (as shown in FIG. 5).

Each template is instantiated through a dynamic type-binding process that reflects the policy's specific semantic context. For example, a conditional phrase such as “if user access is excessive” may bind to a template representing a threshold-violation gate, in which “excessive” is resolved to a concrete risk parameter based on thresholds stored in configuration and threshold store 516 (as shown in FIG. 5). The result is a structured policy logic object, composed of verified sub-blocks, that represents an atomic, executable compliance rule.

Once constructed, the policy logic object is compiled into an intermediate representation (IR) suitable for execution by the reflex logic core 108. In some embodiments, the executable logic construction layer emits policy logic in a form compatible with a stream-processing engine or rules engine, enabling real-time evaluation over high-velocity event data. Because each logic object is derived from a version-controlled policy source and compiled through a formalized, deterministic transformation, the resulting reflex controls are both traceable and auditable: each decision rendered by action decider 510 (as shown in FIG. 5) can be back-linked to a specific clause in the originating policy document, along with the exact compilation chain used to operationalize it.

In certain embodiments, the executable logic construction layer exposes a visual interface for administrative users to inspect or override the compiled logic. This interface may include node-based graph visualizations, embedded test cases, and runtime execution traces, allowing policy managers and compliance officers to validate logic before deployment. By elevating policy enforcement from a manual interpretation layer to a formally compiled logic tier, the executable logic construction layer closes the loop between high-level policy intent and automated reflex decisioning.

In accordance with certain aspects of the present disclosure, an audit ledger 112 appends a hash-linked, time-stamped record of every delta object, context vector, reflex score, remedial or fallback action, and resulting execution status, thereby establishing an immutable chain of custody suitable for regulator-grade audits. In accordance with certain aspects of the present disclosure, platform 100 further comprises a risk-linked insurance modeling engine (not shown in FIG. 1) that translates the platform's live compliance-risk telemetry into actuarial signals consumable by an external insurer. In accordance with certain embodiments, the risk-linked insurance modeling engine subscribes to the stream of reflex-score events that emerge from reflex-score evaluator 508 (as shown in FIG. 5) and aggregates them, together with the impact-severity values already carried in each context vector, into a structured COMPLIANCE_RISK_PROFILE object. The profile records rolling averages of reflex scores, counts and severities of prior violations, and any remediation credits awarded by the time-based risk decay engine, thereby furnishing a standardized snapshot of the insured entity's current compliance posture.

In certain embodiments, the risk-linked insurance modeling engine exposes a bidirectional INSURANCE_PREMIUM_FEEDBACK_CHANNEL (for example, a mutually authenticated REST or gRPC API) through which it publishes every new COMPLIANCE_RISK_PROFILE to the insurer and, in return, receives updated premium or coverage parameters. Inside the engine, a PREMIUM_ADJUSTMENT_SIGNAL logic block computes a scalar adjustment factor by weighting the most recent reflex score against the paired impact-severity metric; sustained low risk drives the factor downward, while a high-severity violation pushes the factor upward. The resulting factor is embedded in each outbound profile so that premiums can be raised or lowered in near real time, eliminating month- or year-long lags between behavior and cost.

To minimize post-loss disputes, a Claim-Denial Prevention mechanism cross-checks every violation's VIOLATION_TIMESTAMP against the insurer's COVERAGE_WINDOW before the risk-linked insurance modeling engine issues its profile. When the timestamp falls outside the window, or when remediation cleared the violation prior to any loss, the risk-linked insurance modeling engine tags the event accordingly, ensuring that the insurer cannot later deny a claim on misaligned timing grounds. All outbound profiles, incoming premium responses, and denial-prevention annotations are committed to audit ledger 112 with the same hash-linked integrity safeguards that protect policy-change artifacts, thereby creating an immutable provenance chain connecting underwriting decisions to their originating compliance data.

In certain embodiments, a Reflex Graph UI 140 renders an interactive causality graph that links the originating policy change to its mapped targets and executed controls. In accordance with certain embodiments, an administrator/policy configuration interface 150 enables authorized personnel to register new rule feeds, adjust threshold parameters, and upload execution packs without redeploying the core engine.

As shown in FIG. 1, directional data arrows between the foregoing elements illustrate the life cycle of a policy change: raw policy versions flow from sources 120 to interface 102; delta objects travel from delta detection engine 104 to contextual mapping engine 106; context vectors pass from contextual mapping engine 106 to reflex logic core 108; reflex scores and remedial-action descriptions move from reflex logic core 108 to orchestration module 110; execution status cycles back to reflex logic core 108 and onward to audit ledger 112; and every artifact ultimately surfaces through Reflex Graph UI 140 for real-time oversight. Together, these interlocking components demonstrate a self-contained system that senses regulatory change, reasons over its impact, acts across heterogeneous environments, and stores all actions and data assets in an auditable ledger.

In accordance with certain aspects of the present disclosure, the platform further comprises an explainability engine (not shown in FIG. 1) that generates human-readable justifications for decisions rendered by the reflex logic core 108. The explainability engine operates as a parallel processor that listens to the same event stream and context vectors consumed by the action decider 510 (as shown in FIG. 5), but instead of executing controls, it constructs a transparent, auditable narrative that explains why each decision was made, what data it was based on, and which policy clauses or thresholds were invoked.

To perform this function, the explainability engine parses the executed logic chain associated with each reflex decision, extracts the sequence of evaluated conditions, triggered events, and matched thresholds, and maps these elements to a corresponding set of natural-language explanation templates stored in an internal justification library. The explainability engine then assembles a structured explanation object, which includes: (i) the triggering context (e.g., a policy change, system alert, or environmental input); (ii) the evaluated risk and reflex score; (iii) the executed control or suppressed action; and (iv) the governing policy clause or logic block, with version identifiers for traceability.

In certain embodiments, the explanation object is rendered directly into a graphical user interface via the Reflex Graph UI 140, where users can expand any node to view the logic trace and justification text associated with that node. In other embodiments, the explanation object is exported as a standalone PDF, JSON, or XML report, enabling integration into enterprise GRC systems, audit portals, or third-party claim-review workflows. Because every reflex action has a corresponding explanation object with formal provenance links to the originating policy, event data, and compiled logic, the system delivers defensible automation, where even autonomous, real-time enforcement can be transparently justified under scrutiny.

In further embodiments, the explainability engine supports counterfactual mode, wherein platform 100 allows a user (e.g., an auditor or administrator) to simulate alternative inputs and observe what would have happened under different conditions. This enables impact analysis, scenario planning, and post-incident review using the same logic infrastructure that governs live enforcement. By equipping compliance teams with interactive visibility into both past and hypothetical behavior, the explainability engine provides a critical layer of trust and accountability in automated decision-making environments.

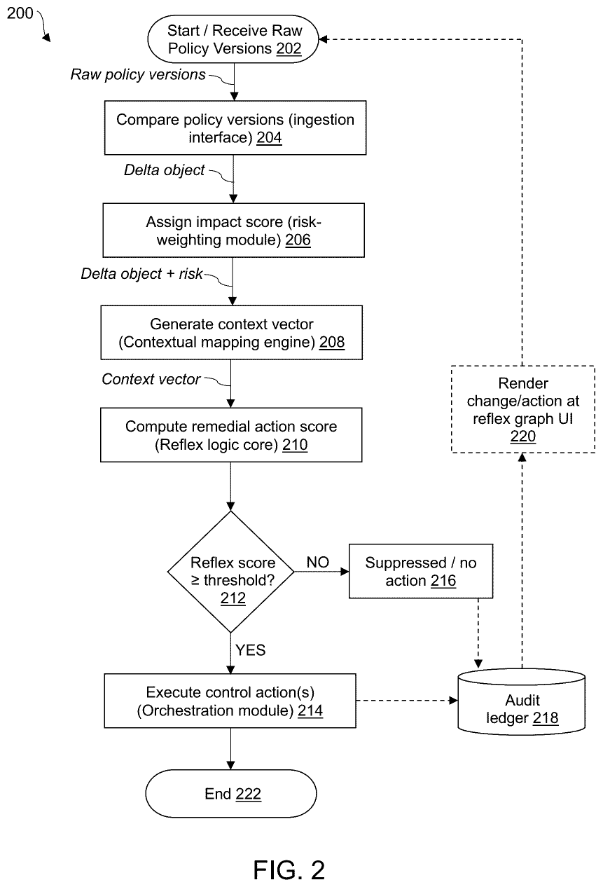

Referring now to FIG. 2, a data-flow diagram showing the end-to-end compliance workflow 200 executed by the automated policy-intervention platform is shown. The operations in compliance workflow 200 may be performed in the order presented, in a different order, or simultaneously. Further, in some exemplary embodiments, some of the operations may be omitted, added, modified, skipped, or the like without departing from the scope of the invention. In accordance with certain aspects of the present disclosure, compliance workflow 200 may be embodied within one or more operations of platform 100, as shown in FIG. 1.

In accordance with certain aspects of the present disclosure, compliance workflow 200 traces a single compliance cycle from receipt of a new policy version through execution, audit logging, and user-interface presentation. In certain embodiments, compliance workflow 200 begins when the platform (e.g., platform 100 of FIG. 1) receives raw policy versions at a start node 202, which passes both the first and second versions of a document (e.g., a statute, regulation, etc.) to an ingestion interface. The interface immediately tags each version with provenance metadata, normalizes file format, and forwards the text downstream (Block 204). At block 204, delta-detection engine compares the two versions clause by clause, tokenizes any substantive linguistic changes, and emits a structured delta object. At block 206, a risk-weighting module evaluates the delta object's potential impact by consulting predefined severity and likelihood heuristics, then appends an impact-severity score to the object, producing the artifact labeled Delta object+risk. At block 208, the enriched delta object advances to a contextual-mapping engine, which cross-references asset registries and jurisdictional taxonomies to pinpoint every system, data store, or user role affected by the detected change. In accordance with certain embodiments, the contextual-mapping engine outputs a fully populated context vector that embeds target identifiers, jurisdiction tags, and effective dates.

In accordance with certain aspects of the present disclosure, at block 210, a reflex logic core receives both the delta object and context vector, executes a chain-of-thought prompt stack on a large-language-model inference service, and computes a numeric reflex score that predicts the compliance risk of taking no action. The numeric reflex score passes to decision diamond 212, which assesses the numeric reflex score against a configurable threshold. When the numeric reflex score meets or exceeds the threshold, compliance workflow 200 proceeds along the YES branch to block 214. At block 214, an orchestration module converts the remedial control description into programmatic calls (e.g., RESTful API requests, message-bus events, or direct database statements) that target systems can execute and streams real-time status back to the core. If the numeric reflex score falls below the threshold, compliance workflow 200 moves along the NO branch to block 216. At block 216, a suppression terminator records a “no action” outcome for transparency.

In accordance with certain aspects of the present disclosure, regardless of the branch taken, compliance workflow 200 appends an immutable record of each delta object, context vector, reflex score, executed or suppressed control action, and resulting execution status to an audit ledger at block 218. In accordance with certain embodiments, the audit ledger comprises a hash-linked, tamper-evident store. Immediately after ledgering, compliance workflow 200 is configured to execute one or more steps or operations at block 220 to render a reflex graph at a user-interface module that visually links the originating policy change to its mapped targets and executed controls, enabling real-time oversight by compliance officers. In accordance with certain aspects of the present disclosure, compliance workflow 200 completes at end node 222, after which the platform awaits the next incoming policy version, thereby establishing a continuous loop of automated detection, reasoning, action, and auditability.

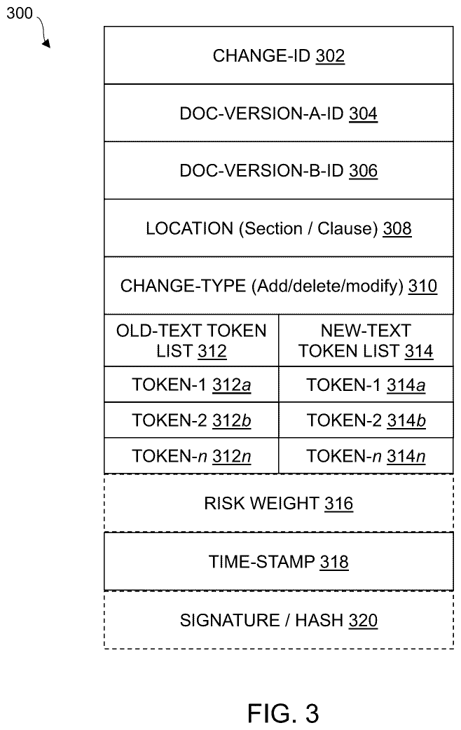

Referring now to FIG. 3, a detailed schematic of an exemplary data structure for a delta object 300 is shown. As shown in FIG. 3, delta object 300 depicts change tokens, metadata fields, and an optional risk-weight attribute. In accordance with certain embodiments, delta object 300 appears as a structured record that the delta-detection engine builds for every substantive textual change. In accordance with certain embodiments, a CHANGE-ID 302 holds a 128-bit UUID expressed in canonical hexadecimal, so every delta object remains globally unique and traceable across distributed replicas. In accordance with certain embodiments, a DOC-VERSION-A-ID 304 and DOC-VERSION-B-ID 306 store secure SHA-256 hashes of the earlier and later policy documents, enabling later integrity checks and eliminating reliance on mutable file names. In accordance with certain embodiments, a LOCATION field 308 records a fully qualified citation string (e.g., such as “§ 3.2.1(a)→§ 3.2.1(b)”) that pinpoints the precise clause boundary where the change occurs and supports hyperlink navigation inside the Reflex Graph UI. In certain embodiments, a CHANGE-TYPE field 310 carries a normalized token selected from an enumerated set (e.g., {ADD, DELETE, MODIFY}), allowing downstream logic to branch efficiently without natural-language parsing.

In accordance with certain aspects of the present disclosure, an OLD-TEXT TOKEN LIST 312 and a NEW-TEXT TOKEN LIST 314 each contain an ordered array of token sub-elements 312a-312n and 314a-314n. In certain embodiments, every sub-element stores a lemmatized word or punctuation mark together with its original byte offset, part-of-speech tag, and cryptographic checksum such that the system can reconstruct the pre-change and post-change phrases byte-for-byte during audit replay. In certain embodiments, OLD-TEXT TOKEN LIST 312 and a NEW-TEXT TOKEN LIST 314 maintain identical indexing so sub-element 312a aligns with sub-element 314a, thereby letting the mapping engine compute edit distance and semantic drift without expensive re-tokenization.

In accordance with certain embodiments, a RISK-WEIGHT field 316 stores a floating-point value between 0.0 and 1.0 generated by a gradient-boosted classifier that considers clause type, jurisdiction, historical intervention data, and keyword sentiment. In certain embodiments, a TIME-STAMP field 318 logs creation time (e.g., in RFC 3339 format) with millisecond precision, and a monotonic counter ensures strict ordering even when the ingestion interface processes multiple policy feeds in parallel. Finally, a SIGNATURE/HASH field 320 stores an HMAC-SHA512 digest computed over the entire record, signed with the platform's hardware-security-module root key, so any bit-level alteration immediately breaks verification during ledger commit. In accordance with certain aspects of the present disclosure, the schema for delta object 300 enabled downstream modules to map changes to impacted assets, calculate reflex scores, and generate remedial controls while retaining an immutable forensic trace.

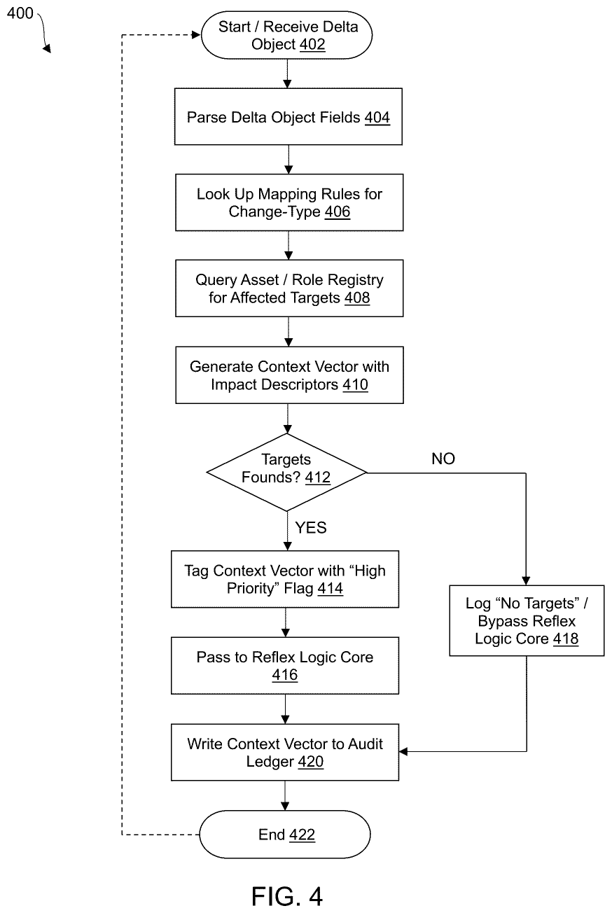

Referring now to FIG. 4, a flowchart illustrating operations of a routine 400 performed by the contextual-mapping engine to resolve a delta object into affected targets and to emit a context vector with impact descriptors is shown. The operations in routine 400 may be performed in the order presented, in a different order, or simultaneously. Further, in some exemplary embodiments, some of the operations may be omitted, added, modified, skipped, or the like without departing from the scope of the invention.

In accordance with certain aspects of the present disclosure, routine 400 comprises a sequence of steps or operations 402-422 in which a contextual-mapping engine (e.g., contextual-mapping engine 106 of FIG. 1) transforms a single delta object into a context vector that the reflex logic core can interpret without additional look-ups. In accordance with certain aspects of the present disclosure, routine 400 is initiated at start node 402. In certain embodiments, start node 402 comprises one or more steps or operations by which the contextual-mapping engine receives a freshly minted delta object whose change identifier, version hashes, clause location, and cryptographic signature have already been validated by the delta-detection pipeline. In certain embodiments, the one or more steps or operations at start node 402 also logs an ingest timestamp so that later audit queries can reconstruct exact processing latency. Routine 400 may further comprise one or more steps or operations (e.g., via a parse module) to immediately parse the JSON payload, verify a HMAC-SHA512 signature against the platform's hardware-security-module root key, decompress any attached diff fragments, coerce enumerated tokens to a canonical case, and reject the object if it carries a stale schema version (block 404). In accordance with certain aspects of the present disclosure, an output of block 404 ensures that every downstream branch consumes syntactically identical inputs.

In accordance with certain aspects of the present disclosure, routine 400 proceeds with one or more steps or operations for consulting a rule-mapping table stored in an in-memory key-value cache (block 406). In accordance with certain embodiments, each key corresponds to a CHANGE-TYPE token such as ADD, DELETE, or MODIFY, while the value specifies one or more asset-selection predicates, a jurisdiction filter (e.g., expressed as ISO-3166 codes), a default impact-severity baseline, and a list of execution-template hints. In accordance with certain embodiments, the mapping table carries its own version number and time-to-live so that operators can hot-swap rule packs without pausing the engine. In accordance with certain aspects of the present disclosure, routine 400 proceeds with one or more steps or operations for querying the selected predicates against an asset-role registry that integrates microservice manifests, IAM directories, Kubernetes labels, and database-schema catalogs (block 408). In certain use cases, block 408 may query certain industry-specific registries, such as credentialing records in a healthcare licensing use case. In certain embodiments, the registry engine executes a vector-search index for textual fields and a property graph query for hierarchical relationships, returning a fully deduplicated list of target identifiers together with jurisdiction tags, asset types, and current operational states.

In accordance with certain aspects of the present disclosure, routine 400 proceeds with one or more steps or operations for generating a context vector (block 410). In certain embodiments, the context vector may comprise one or more fields, including, but not limited to: the delta's change identifier; every matched target identifier; the governing jurisdiction code; the higher of the baseline impact-severity from the mapping table or the statistical risk score carried in the delta object; an effective-date that honors any grace period encoded in the rule text; and a provisional execution-template reference. In certain embodiments, block 410 comprises one or more steps or operations for calculating a composite priority metric by summing the normalized impact-severity and likelihood values and multiplying by a jurisdiction weight factor. In said embodiments, the metric becomes part of the vector and supports later reflex-score derivation. Routine 400 may proceed to a decision diamond 412. In certain embodiments, decision diamond 412 evaluates the length of the matched-target list. In certain embodiments, if the list contains at least one entry routine 400 proceeds along the YES path to block 414. In accordance with certain embodiments, block 414 comprises one or more steps or operations wherein the engine tags the context vector with a HIGH-PRIORITY flag if the composite metric exceeds a configurable threshold or if the jurisdiction mandates same-day intervention. In certain embodiments, the tag causes downstream logic to bypass user-confirmation gates and accelerate execution. In accordance with certain embodiments, block 416 comprises one or more steps or operations for steaming the fully annotated context vector, in conjunction with the original delta object, across a mutually-authenticated gRPC channel into the reflex logic core (e.g., reflex logic core 108 of FIG. 1) and waits for an acknowledgment that the data reached durable storage on the inference subsystem.

In accordance with certain aspects of the present disclosure, if the matched-target list is empty, routine 400 proceeds along the NO path to block 418. In accordance with certain embodiments, block 418 comprises one or more steps or operations wherein the engine emits a reason code (e.g., NO_TARGETS_IN_SCOPE, DEPRECATED_RULE, or OUT-OF-JURISDICTION) and records the decision in an internal metrics counter. Block 418 may further comprise one or more steps or operations to suppress further processing for that delta object to conserve compute cycles. Regardless of the branch taken, routine 400 comprises one or more steps or operations to write an append-only entry to audit ledger (block 420). In accordance with certain embodiments, block 420 may comprise one or more steps or operations to bundle the delta object, the context vector (or the suppression reason), the composite priority metric, the YES/NO branch indicator, and a monotonic sequence number, inside a block that links back to the previous ledger hash. In certain embodiments, the block may be notarized by an external time-stamp authority. In accordance with certain embodiments, end node 422 closes the transaction and signals the ingestion scheduler that a contextual-mapping engine (e.g., contextual-mapping engine 106) is ready to accept the next delta object, thereby sustaining a continuous, low-latency pipeline from change detection to reflex-score computation.

Referring now to FIG. 5, a logic diagram 500 of the reflex logic core, showing prompt stack stages, reflex-score evaluation, and conditional suppression of remedial actions is shown. The operations in logic diagram 500 may be performed in the order presented, in a different order, or simultaneously. Further, in some exemplary embodiments, some of the operations may be omitted, added, modified, skipped, or the like without departing from the scope of the invention.

In accordance with certain aspects of the present disclosure, logic diagram 500 reveals the fine-grained pipeline executed by reflex logic core 108. As shown in FIG. 5, logic diagram 500 begins at an ingress conduit 541 that transports a cryptographically signed bundle containing a delta object and its companion context vector. In accordance with certain embodiments, a prompt-stack builder 502 receives the bundle and constructs a three-tier composite prompt. In accordance with certain embodiments, a system prompt segment 502a injects static governance directives, red-team guardrails, and policy citations so the large-language model cannot deviate from enterprise ethics or jurisdictional mandates. In accordance with certain embodiments, a context prompt segment 502b embeds machine-readable metadata drawn from the context vector, including target identifiers, asset types, jurisdiction codes, composite priority metric, and effective dates, thereby localizing the forthcoming reasoning task to the precise operational footprint. In accordance with certain embodiments, a delta prompt segment 502c supplies a verbatim excerpt of the clause change, the enumerated change-type token, the original and revised text fragments, and the numeric risk-weight produced by the delta-detection pipeline. In accordance with certain embodiments, prompt-stack builder 502 concatenates these segments in canonical order, appends a SHA-256 content checksum, and assigns a monotonic execution identifier before streaming the resulting prompt package to an LLM inference engine 504.

In accordance with certain aspects of the present disclosure, LLM inference engine 504 invokes a deterministic large-language-model endpoint. In certain embodiments, the deterministic large-language-model endpoint may comprise a temperature of 0.0, a top-p of 1.0, and a strict stop-sequence that prevents prompt leakage. In certain embodiments, LLM inference engine 504 returns a raw response that pairs free-form justification text with a structured JSON plan containing a candidate remedial action, a triggering condition expressed in Boolean logic, an authorized actor reference, and an estimated time-to-execution field. In certain embodiments, a reasoning-trace filter 506 parses the raw response, redacts personally identifying information, and serializes the remaining chain-of-thought tokens into a compressed CBOR object that it immediately commits to immutable audit ledger 112 along with the execution identifier and model version tag, thereby satisfying provenance and reproducibility requirements.

In accordance with certain embodiments, a reflex-score evaluator 508 decomposes the structured JSON plan, extracts the LLM-supplied confidence score, and computes a reflex score by applying a weighted formula that sums the normalized impact-severity, likelihood, and confidence values, then multiplies by an urgency coefficient retrieved from a configuration and threshold store 516. In accordance with certain embodiments, configuration and threshold store 516 maintains per-jurisdiction suppression thresholds, rotating API keys, and model-version allow lists. Configuration and threshold store 516 exposes an atomic read path so reflex-score evaluator 508 can pull threshold data without race conditions even while DevOps staff hot-swap configuration bundles. In accordance with certain embodiments, the computed reflex score, the governing threshold, and a hash of the scoring algorithm are passed to an action decider 510.

In accordance with certain aspects of the present disclosure, action decider 510 compares the reflex score against the active threshold and branches deterministically. When the score falls below the threshold, action decider 510 stamps the execution identifier with a SUPPRESSED status code, appends an explanatory note that cites the score and threshold, and records the outcome in audit ledger 112 for later auditor review. When the score meets or exceeds the threshold, action decider 510 forwards the structured JSON plan to action templater 512.

In accordance with certain aspects of the present disclosure, action templater 512 selects a domain-specific execution template (e.g., such as a Kubernetes admission-controller patch, a payroll-system API call, or a hospital-privileges suspension script) based on the action-template reference carried in the context vector. In certain embodiments, action templater 512 resolves variable placeholders with runtime values, embeds a rollback stanza that references a fallback template, and signs the fully expanded remedial control action with the platform's private key. In accordance with certain embodiments, the signed action exits reflex logic core through a mutually authenticated channel to orchestration module 110, while action templater 512 simultaneously streams the action descriptor, signature, and associated reflex score into audit ledger 112, thereby completing an immutable chain linking the original clause change to the exact machine-executed control. In accordance with certain aspects of the present disclosure, each conduit in logic diagram 500 is labeled to show artifact lineage, ensuring that relevant stakeholder users can replay every decision from prompt construction through threshold evaluation and final action emission.

In accordance with certain embodiments, reflex logic core 108 comprises a prompt execution and versioning engine. In accordance with said embodiments, the prompt execution and versioning engine persistently captures every chain-of-thought prompt stack generated by the reflex logic core before the stack proceeds to the orchestration module. The prompt execution and versioning engine assigns a monotonically increasing version identifier, timestamps the prompt stack to micro-second resolution, and computes a cryptographic digest (e.g., such as a SHA-256 hash) over the prompt text and salient context metadata. It then stores the resulting tuple of version identifier, timestamp, hash, and prompt stack in an append-only journal that is logically linked to the audit ledger, thereby producing an immutable, replayable history of all prompts that have influenced downstream control actions.

During normal operation, the reflex logic core calls the prompt execution and versioning engine through an internal API to obtain the latest “active” prompt stack. If a compliance officer invokes a rollback command, the prompt execution and versioning engine locates the requested prior version, verifies its digest against the stored hash, and atomically re-issues the earlier prompt stack to the core while recording the rollback event in the ledger. Because every prompt version carries both provenance metadata and a bidirectional pointer to the remedial control actions that resulted from its execution, the system can reconstruct an end-to-end reasoning trace for audit or post-incident forensics without relying on mutable logs elsewhere in the platform.

By situating the versioning engine within the signal path between the reflex logic core and the orchestration module, reflex logic core 108 ensures that no prompt reaches external system interfaces unless it has first been version-stamped and cryptographically sealed. This placement delivers a governance-grade chain of custody for large-language-model interactions while preserving the reflexive, real-time nature of the compliance engine described throughout the specification.

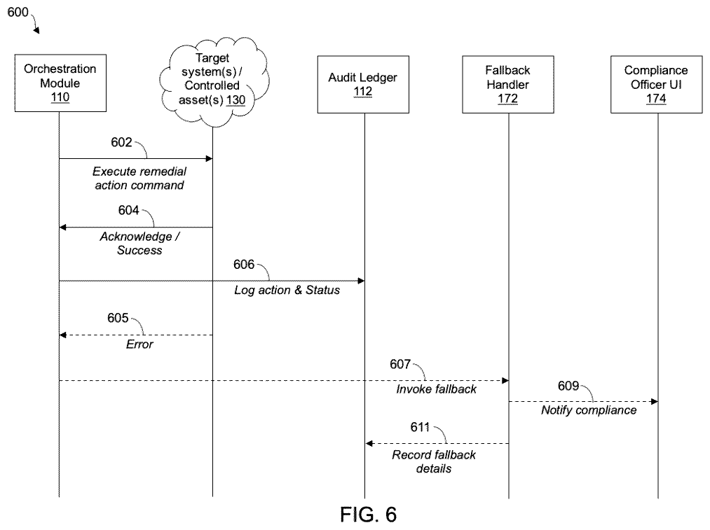

Referring now to FIG. 6, a sequence diagram 600 depicting orchestration-module interactions with external systems (e.g., HRIS, EMR, payroll, or identity-management APIs) to execute remedial and fallback control actions is shown. In accordance with certain aspects of the present disclosure, sequence diagram 600 exposes, minute-by-minute, how orchestration module 110 drives an entire control-execution transaction, confirms success, and self-remediates on fault while preserving a tamper-evident audit trail. As shown in FIG. 6, the leftmost lifeline represents orchestration module 110, whose runtime container hosts an idempotent dispatcher, a TLS-authenticated API client, and a latency watchdog that together create an activation bar spanning orchestration module 110 during both success and error arcs. Immediately after reflex logic core 108 (as shown in FIG. 5) signs and forwards a remedial control action, orchestration module 110 transmits message 602 (labeled Execute Remedial Action Command in FIG. 6) to target system 130. In accordance with certain embodiments, that message bundles a JSON action descriptor, a monotonic execution-identifier, a SHA-512 checksum over the payload, and a JOSE Web Signature signed by the platform's hardware-security-module root key, thereby assuring integrity and non-repudiation at delivery.

In accordance with certain aspects of the present disclosure, target system 130 may represent an HRIS endpoint, a Kubernetes API server, or a hospital-privileges microservice (e.g., in a healthcare use case). On the happy path (messages 602-606), target system 130 completes the requested change (e.g., such as patching a ConfigMap, updating a pay-rate table, or toggling an IAM permission) and returns message 604 (labeled Acknowledge/Success in FIG. 6). Message 604 may comprise an embedded transaction ID, an internal commit hash, a POSIX nanosecond timestamp, and a signed attestation that the change reached durable storage. In certain embodiment, orchestration module 110 comprises a latency watchdog that records the round-trip time and, within the same activation bar, issues message 606 to immutable audit ledger 112. In accordance with certain embodiments, audit ledger 112 records the execution identifier, action descriptor, target response, latency metrics, platform-signature bundle, and a Merkle tree root that chains the new block to the previous entry, thus rendering later tampering computationally infeasible.

In accordance with certain aspects of the present disclosure, if target system 130 emits an error message 605 (labeled Error in FIG. 6), orchestration module 110 triggers its error-handling path. In accordance with certain aspects of the present disclosure, orchestration module 110 examines error message 605 and consults a policy-specific fallback table. For example, in certain exemplary use cases, for a 409 “conflict” on a payroll API, the table might prescribe an automatic retro-adjustment ticket, whereas a 500-series error on a hospital privileges microservice may invoke a privilege-suspension rollback. In accordance with certain embodiments, orchestration module 110 transmits a fallback message 607 (labeled Invoke Fallback in FIG. 6) toward fallback handler 172. In accordance with certain embodiments, fallback handler 172, which may run inside an isolated sandbox for privilege separation, executes the compensating workflow, records an execution trace, and returns a signed completion receipt. Concomitantly, fallback handler 172 issues message 6909 (labeled Notify Compliance in FIG. 6) to a compliance-officer UI 174. In accordance with certain embodiments, a WebSocket client of compliance-officer UI 174 immediately surfaces a banner that lists the execution identifier, original error code, fallback template ID, and current remediation status, allowing real-time human oversight and optional override of the automated decision.

After finishing the compensating action, fallback handler 172 forwards message 611 (labeled Record fallback details in FIG. 6) to audit ledger 112. In accordance with certain embodiments, audit ledger 112 stores the root cause, fallback template identifier, both the original and compensating execution traces, and a double-signature bundle from the dispatcher and the handler to anchor the entire remediation event in the same tamper-evident chain. The final activation bar on audit ledger 112 closes once it has persisted all cryptographic proofs and emitted a commit acknowledgment back to the dispatcher.

In accordance with certain aspects of the present disclosure, solid arrows in FIG. 6 depict the normative success arc, while dashed arrows mark the contingency branch. By detailing every message field, signature exchange, and state transition, from initial command through ledger commit, FIG. 6 demonstrates that the platform enforces remedial controls atomically, verifies success, self-heals on fault, notifies human stakeholders, and indelibly records every micro-event for regulator-grade replayability.

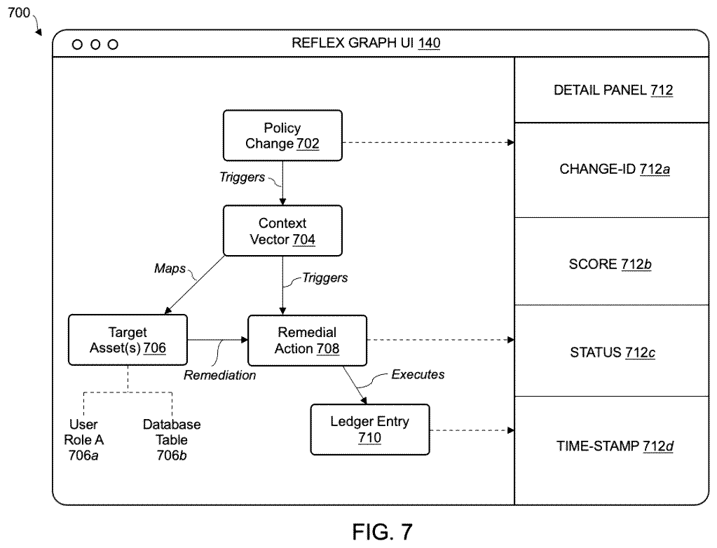

Referring now to FIG. 7, a schematic a reflex graph UI 700 that visually links a policy change to its mapped targets, executed controls, and audit-ledger entry. In certain embodiments, reflex graph UI 700 comprises an embodiment of reflex graph UI 140 as shown in FIG. 1. In accordance with certain aspects of the present disclosure, reflex-graph user-interface 700 renders, in a single window, the full causal chain that links a particular policy change to every downstream artifact created by the automated policy-intervention platform. The left-hand graph pane displays five primary nodes 702-710. In accordance with certain embodiments, a policy-change node 702 is configured to display a policy change, including an internal change identifier. As shown in FIG. 7, an arrow labeled “Triggers” extends from policy-change node 702 to context-vector node 704, signaling that the mapping engine has resolved the clause delta into a discrete set of operational attributes. From context-vector node 704, a second arrow labeled “Maps” descends to target-asset node 706. Target-asset node 706 may comprise sub-nodes such as user-role A 706a and database-table 706b to expose every concrete object that the mapping engine identified. A third arrow labeled “Remediation” progresses from node 706 to remedial-action node 708. As shown in FIG. 7, the arrow's tooltip reveals the selected execution template, the authorized actor, and the reflex score that justified automatic intervention. The final solid arrow labeled “Executes” links node 708 to ledger-entry node 710, confirming that the orchestration module has carried out the control action and persisted all telemetry in the immutable audit ledger.

As shown in FIG. 7, a detail panel 712 occupies the rightmost column of the window and surfaces row-oriented metadata for whichever graph node the user selects. In its default state, detail panel 712 lists change-ID field 712a, composite risk or reflex score field 712b, current status field 712c, and millisecond-resolution timestamp field 712d. In accordance with an exemplary embodiment, selecting node 702 populates field 712b with the raw risk-weight assigned by the delta-detection engine, whereas selecting node 708 replaces that value with the reflex score computed by the logic core. A color-coded border around field 712c turns green for successfully executed controls, amber for suppressed actions, and red for fallback routines, giving compliance officers immediate visual feedback.

In accordance with certain embodiments, all node and edge objects may comprise embedded hyperlinks that open modal dialogs; for example, the policy-change dialog previews the marked-up clause diff; the context-vector dialog enumerates jurisdiction codes, asset types, and effective dates; the remedial-action dialog displays the fully expanded API payload; and the ledger-entry dialog reveals the signed Merkle block and its previous-hash pointer. In certain embodiments, a zoom control may enable drill-down to additional layers, such as nested asset hierarchies or multi-step control sequences, without crowding the primary view. By uniting structural and temporal data in a single, interactive canvas, FIG. 7 demonstrates how the platform furnishes regulator-grade explainability wherein every stakeholder can trace, in real-time, how a specific clause amendment triggers a mapping decision, flows into an automatically selected control, and concludes in a tamper-evident ledger record.

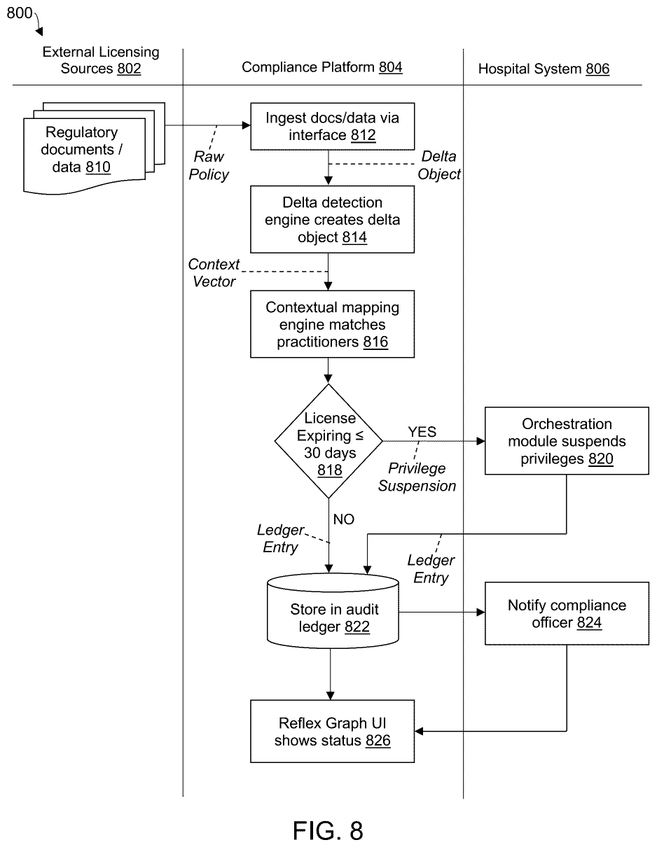

Referring now to FIG. 8, a workflow diagram 800 exemplifying a use case of an automated policy-intervention platform to monitor healthcare-worker licensing requirements is shown. The operations in workflow diagram 800 may be performed in the order presented, in a different order, or simultaneously. Further, in some exemplary embodiments, some of the operations may be omitted, added, modified, skipped, or the like without departing from the scope of the invention. In accordance with certain embodiments, the automated policy-intervention platform comprises platform 100 as shown in FIG. 1.

In accordance with certain aspects of the present disclosure, workflow diagram 800 chronicles an automated license-monitoring cycle across three swim-lanes: External Licensing Sources 802, Compliance Platform 804, and Hospital Systems 806. In the left-most lane, regulatory payload 810 represents a state medical-board bulletin, specialty society directive, or renewal-deadline CSV that arrives through a mutually authenticated HTTPS or SFTP feed. In accordance with certain embodiments, each payload carries a feed-identifier header, a schema-version tag, and an HMAC-SHA-256 checksum that enables the platform to confirm provenance and tamper resistance. Ingestion interface 812 hosts API listeners, OCR pipelines for scanned PDFs, and a metadata enricher that stamps every record with an ingest timestamp, geographic origin, and file-format fingerprint before forwarding the normalized text downstream as the artifact labeled RAW POLICY.

In accordance with certain aspects of the present disclosure, delta-detection engine 814 receives the normalized text together with the immediately prior version extracted from a version cache. The engine tokenizes both documents, lemmatizes clinical terminology, aligns numbered clauses, and runs a semantic-similarity model to ignore non-substantive markup changes. For every substantive difference, it emits a DELTA OBJECT that stores a 128-bit change identifier, old-and new-token arrays, clause citations, a preliminary impact-severity score, and a SHA-512 signature. Contextual-mapping engine 816 ingests this delta object, interrogates a credentialing data lake that federates HRIS profiles, state-license databases, board-certification tables, and Medicare NPI registries, and produces a CONTEXT VECTOR. In accordance with certain embodiments, the vector lists each affected practitioner's unique staff ID, specialty code, license-state abbreviation, current expiration date, and a computed “days-to-lapse” value. It also inherits the delta's impact score and appends a jurisdictional urgency multiplier.

In accordance with certain embodiments, a decision diamond 818 evaluates the vector's minimum “days-to-lapse” against a configurable intervention threshold stored in platform configuration. If YES, i.e., when at least one license will lapse within thirty days, workflow diagram 800 proceeds along the branch to orchestration module 820. In certain embodiments, the orchestration module 820 generates a signed HL7 FHIR message or REST JSON payload (e.g., depending on hospital infrastructure) that directs the privileges subsystem to suspend operating-room scheduling privileges, computer-order-entry rights, or medication-dispensing codes for every practitioner named in the context vector. The subsystem may return a transaction receipt with per-user status codes, which the module verifies before emitting a PRIVILEGE SUSPENSION event to an audit ledger 822. Audit ledger 822 appends a block that bundles the delta object, context vector, execution descriptor, subsystem receipt, and a Merkle-tree pointer to the prior block, thereby preserving an unforgeable chronology. Reflex Graph UI 826 subscribes to the ledger's commit stream, redraws the causal graph in real time, and highlights each affected practitioner node in red so compliance officers can confirm intervention without querying disparate systems.

In accordance with certain aspects of the present disclosure, if decision 818 resolves NO, i.e., indicating every mapped license remains valid for more than thirty days, then workflow diagram 800 routes to notification service 824. In accordance with certain embodiments, notification service 824 constructs a SERVICENOW task or encrypted e-mail addressed to the credentialing desk, attaches the full context vector, sets a due date (e.g., ten days before the earliest expiration) and embeds a deep link that reopens the exact Reflex-Graph view for that delta. In accordance with certain embodiments, notification 824 also writes an audit-ledger block through node 822, recording the “NOTIFY-ONLY” disposition, the scheduled due date, and the escalation policy, thus ensuring auditors can later verify that automated suspension was properly deferred.

As shown in FIG. 8, arrow captions—RAW POLICY, DELTA OBJECT, CONTEXT VECTOR, PRIVILEGE SUSPENSION, and LEDGER ENTRY—appear above their respective conduits, clarifying artifact lineage. By detailing ingestion, diffing, risk scoring, practitioner mapping, threshold evaluation, automated privilege control, deferred notification, real-time visualization, and tamper-evident ledgering, FIG. 8 demonstrates how the platform enforces jurisdiction-specific licensing mandates with millisecond-level telemetry, self-remediating safeguards, and regulator-grade auditability.

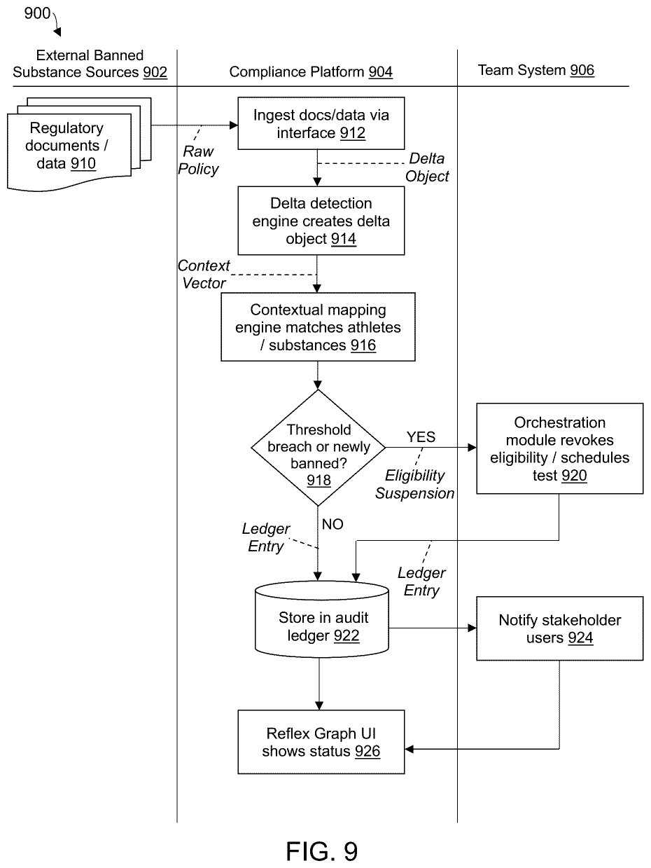

Referring now to FIG. 9, a workflow diagram 900 exemplifying a use case of the automated policy-intervention platform to monitor banned substances rules for sports teams is shown. The operations in workflow diagram 900 may be performed in the order presented, in a different order, or simultaneously. Further, in some exemplary embodiments, some of the operations may be omitted, added, modified, skipped, or the like without departing from the scope of the invention. In accordance with certain embodiments, the automated policy-intervention platform comprises platform 100 as shown in FIG. 1.

In accordance with certain aspects of the present disclosure, workflow diagram 900 depicts an anti-doping compliance cycle laid out in three parallel swim-lanes—External Banned-Substance Sources 902, Compliance Platform 904, and Team Systems 906—so observers can follow each artifact and decision from rule ingestion to athlete eligibility. In accordance with certain aspects of the present disclosure, feed of regulatory documents or data 910 arrives from entities such as the World Anti-Doping Agency, the governing league office, and the club's own medical advisory board. In certain embodiments, every payload carries a schema-version tag, a checksum, and a provenance header that identifies the issuing body and effective date. In certain embodiments, ingestion interface 912 normalizes file formats, validates signatures, enriches each record with ingest timestamps and jurisdiction codes, and forwards the text downstream as RAW POLICY.

In accordance with certain aspects of the present disclosure, delta-detection engine 914 receives the normalized text together with the previously cached version, tokenizes both documents, aligns section numbers, and applies a semantic-similarity model that filters out cosmetic edits. For every substantive difference (e.g., such as the addition of a synthetic stimulant or a lowered nanogram threshold), the engine emits a DELTA OBJECT that stores a 128-bit change identifier, lemmatized token arrays, clause citations, a preliminary impact-severity score, and a cryptographic signature. In accordance with certain embodiments, contextual-mapping engine 916 ingests the delta object, interrogates an athletic data lake that merges roster metadata, supplement-declaration logs, and biological-passport time series, and builds a CONTEXT VECTOR. The vector lists each athlete's roster ID, substance-use profile, recent biomarker readings, therapeutic-use exemptions, and a computed proximity-to-threshold metric that indicates how close the athlete is to violating the new limit.

In accordance with certain aspects of the present disclosure, workflow diagram 900 comprises a decision diamond 918 that compares the vector's maximum proximity-to-threshold against a configurable intervention threshold. In accordance with certain aspects of the present disclosure, when any athlete already breaches, or is projected to breach, the updated limit, workflow diagram 900 moves along the YES branch into orchestration module 920. In accordance with certain embodiments, orchestration module 920 generates a signed payload that instructs the athlete-management system to revoke competition eligibility, schedule an immediate confirmatory blood test, and update the athlete's dashboard with a hold status. The management system returns a transaction receipt that the module verifies before writing a LEDGER ENTRY to immutable audit ledger 922. Audit ledger 922 stores the delta object, the full context vector, the signed eligibility-suspension command, the management-system receipt, and a Merkle-root pointer that links the block into the tamper-evident chain. In accordance with certain embodiments, Reflex Graph UI 926 subscribes to ledger commits, refreshes in real time, and highlights each ineligible athlete node so coaches, compliance officers, and medical staff gain instant situational awareness without polling multiple platforms.

In accordance with certain aspects of the present disclosure, if decision 918 resolves NO (i.e., indicating that all mapped athletes remain under the revised limits), workflow diagram 900 routes the flow to notification service 924. In certain embodiments, notification service 924 assembles an encrypted e-mail and a SERVICENOW task directed to sports-medicine and coaching staff, appends the full context vector and the clause excerpt, sets a due date aligned with the rule's effective date, and embeds deep links that reopen the contextual Reflex-Graph view. Notification server 924 may also push a ledger entry through node 922, recording the NOTIFY-ONLY disposition, the roster IDs involved, and the escalation policy, thereby enabling auditors to verify that no eligibility revocation occurred, and that human follow-up was scheduled.

As shown in FIG. 9, arrow captions—RAW POLICY, DELTA OBJECT, CONTEXT VECTOR, PRIVILEGE SUSPENSION, and LEDGER ENTRY—appear above their respective conduits, clarifying artifact lineage. By detailing ingestion, diffing, risk scoring, practitioner mapping, threshold evaluation, automated privilege control, deferred notification, real-time visualization, and tamper-evident ledgering, FIG. 9 demonstrates how the platform enforces banned-substance rules with millisecond-level telemetry, self-remediating safeguards, and regulator-grade auditability.

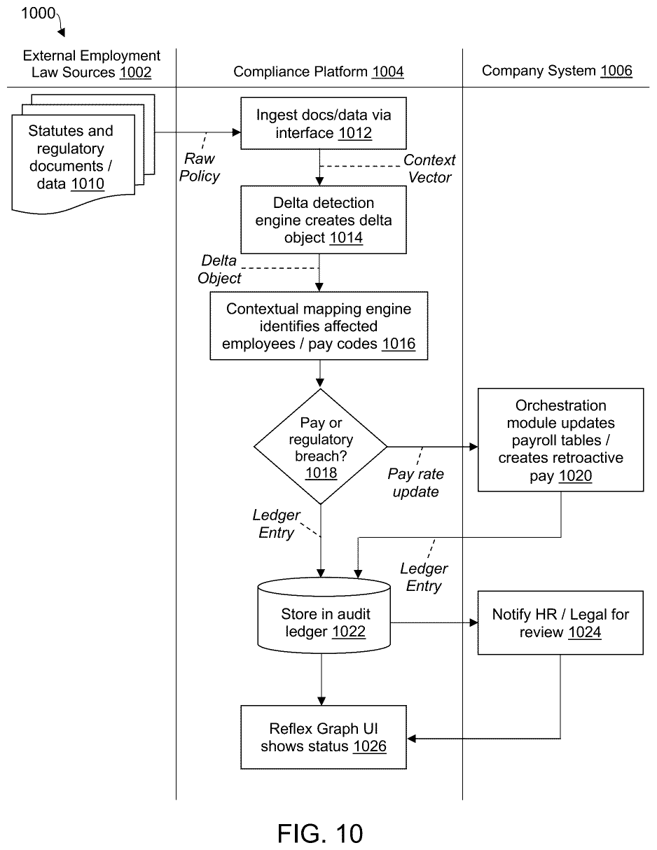

Referring now to FIG. 10, a workflow diagram 1000 exemplifying a use case of the automated policy-intervention platform to monitor to enforce multi-jurisdiction employment laws for employers is shown. The operations in workflow diagram 1000 may be performed in the order presented, in a different order, or simultaneously. Further, in some exemplary embodiments, some of the operations may be omitted, added, modified, skipped, or the like without departing from the scope of the invention. In accordance with certain embodiments, the automated policy-intervention platform comprises platform 100 as shown in FIG. 1.

In accordance with certain aspects of the present disclosure, a workflow diagram 1000 traces a multi-jurisdiction employment-law compliance cycle across three swim-lanes—External Employment-Law Sources 1002, Compliance Platform 1004, and Company Systems 1006—so reviewers can follow every artifact and decision from statute ingestion to payroll remediation. In the left-hand lane, statutes and regulatory documents 1010 arrive from state labor departments, the U.S. Department of Labor, and Equal Employment Opportunity Commission feeds. Each payload may comprise a schema-version tag, a provenance header that identifies the issuing jurisdiction, and an HMAC checksum that ensures tamper resistance. In accordance with certain embodiments, ingestion interface 1012 validates the signature, normalizes file format, enriches the record with an ingest timestamp and ISO-3166 location code, and forwards the normalized text downstream as RAW POLICY.

In accordance with certain aspects of the present disclosure, delta-detection engine 1014 retrieves the immediately preceding version from a version cache, aligns section numbers, tokenizes both documents, and runs an n-gram semantic-diff model tuned to ignore citation renumbering and whitespace edits. For every substantive difference (e.g., such as a higher state minimum wage or a newly banned non-compete clause), the engine emits a DELTA OBJECT that contains a 128-bit change identifier, clause citations, lemmatized token arrays, a preliminary impact-severity score, and a SHA-512 signature. In accordance with certain embodiments, contextual-mapping engine 1016 consumes the delta object, queries an enterprise HRIS, union-contract repository, and time-and-attendance logs, and assembles a CONTEXT VECTOR listing every employee whose pay code, overtime status, or contractual clause now conflicts with the revised rule. In certain embodiments, the vector also embeds a computed wage-gap metric that expresses the dollar difference between current pay and the new statutory minimum.

In accordance with certain aspects of the present disclosure, workflow diagram 1000 comprises a decision diamond 1018 that compares, for example, a maximum wage-gap metric and related regulatory thresholds (e.g., in accordance with certain use cases). In accordance with certain exemplary use cases, when any employee falls short of the new requirement, flow proceeds along the YES branch to orchestration module 1020. In accordance with certain embodiments, orchestration module 1020 constructs a signed JSON payload that updates payroll-rate tables, generates retroactive wage-adjustment entries with effective dates back to the statute's intervention date, and queues notification stubs for affected employees. In certain embodiments, the payroll engine returns a transaction receipt listing each updated pay code, the retro-adjustment amount, and commit hashes. In certain embodiments, orchestration module 1020 verifies the receipt and writes a LEDGER ENTRY to immutable audit ledger 1022 that captures the delta object, context vector, execution descriptor, target-system receipt, and a Merkle-root pointer linking the block into the tamper-evident chain. In certain embodiments, Reflex Graph UI 1026 subscribes to ledger commits, renders an updated causal graph, and highlights each remediated employee node in green, enabling HR and compliance personnel to confirm intervention without querying multiple systems.

In accordance with certain aspects of the present disclosure, if decision 1018 resolves NO (i.e., indicating no pay or regulatory breach), then workflow diagram 1000 routes to notification service 1024. In accordance with certain embodiments, notification service 1024 assembles an encrypted e-mail and creates a SERVICENOW ticket addressed to HR and legal departments, attaches the full context vector and clause excerpt, sets a due date aligned to the rule's effective date, and embeds a deep link to reopen the specific Reflex-Graph view. In accordance with certain embodiments, notification 1024 also submits a ledger block through node 1022, recording the NOTIFY-ONLY disposition, the roster IDs involved, and the escalation policy, thereby furnishing auditors proof that no automatic payroll change was required, and that human follow-up was scheduled.

As shown in FIG. 10, arrow captions—RAW POLICY, DELTA OBJECT, CONTEXT VECTOR, PRIVILEGE SUSPENSION, and LEDGER ENTRY—appear above their respective conduits, clarifying artifact lineage. By detailing ingestion, diffing, risk scoring, practitioner mapping, threshold evaluation, automated privilege control, deferred notification, real-time visualization, and tamper-evident ledgering, FIG. 10 demonstrates how the platform enforces multi-jurisdiction employment laws with millisecond-level telemetry, self-remediating safeguards, and regulator-grade auditability.

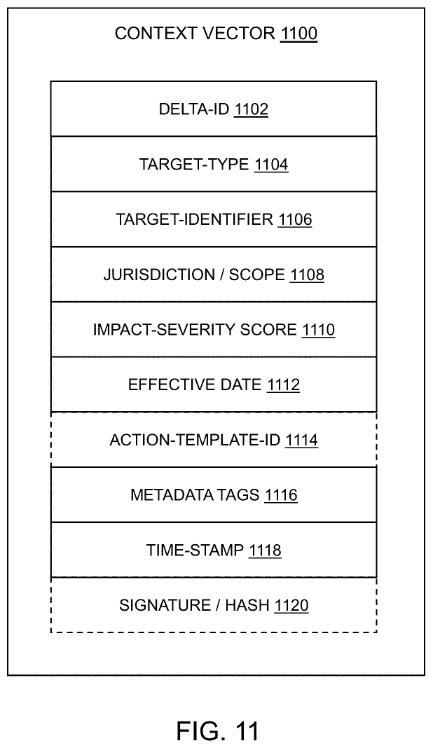

Referring now to FIG. 11, a schematic view of an exemplary context vector 1100 showing fields such as delta-ID links, target identifiers, jurisdiction, risk score, optional metadata, and associated timestamps is shown. Context vector 1100 may comprise any context vector described in the foregoing specification. In accordance with certain aspects of the present disclosure, context-vector record 1100 appears as a horizontally partitioned container that preserves every attribute the mapping engine needs to transmit operational context to the reflex logic core while maintaining a tamper-evident audit trail. As shown in FIG. 11, a first row labeled DELTA-ID 1102 stores the 128-bit change identifier copied verbatim from the delta object so auditors can trace causality from clause change to final control. The next row, TARGET-TYPE 1104, carries an enumerated token (e.g., such as MICROSERVICE, USER-ROLE, DATABASE-SCHEMA, or PHYSICAL-DEVICE) that lets downstream templates branch without natural-language parsing. In accordance with certain embodiments, a TARGET-IDENTIFIER 1106 holds the canonical name or GUID of the affected asset. In said embodiments, the mapping engine matches multiple assets, the field collapses into an array in which each element embeds the asset's registry path and a checksum of its current configuration.

In accordance with certain embodiments, a JURISDICTION/SCOPE 1108 captures an ISO-3166 region code or contractual scope flag that dictates which intervention threshold the reflex-score evaluator must consult. An IMPACT-SEVERITY SCORE 1110 may contain a normalized floating-point value between 0 and 1 that equals the larger of the baseline severity assigned by the rule-mapping table and the risk-weight imported from the delta object, thereby ensuring that risk never decreases as the record moves downstream. In accordance with certain embodiments, an EFFECTIVE DATE 1112 stores either the statutory effective date parsed from the clause or, when absent, the system-timestamp of delta ingestion. The orchestration module may use this date to decide whether retroactive remediation is required.

In accordance with certain embodiments, an ACTION-TEMPLATE-ID 1114 holds a hash pointer into the execution-template library so an action templater (e.g., action templater 512 in FIG. 5) can retrieve the correct control skeleton without another database join. As shown in FIG. 11, the dashed borders around this row indicate that template selection remains optional until the reflex logic core confirms the need for intervention. In certain embodiments, METADATA TAGS 1116 provides a repeatable list in which each sub-element stores a key, a scalar or JSON value, and a source timestamp; examples include SHIFT-CODE=“RN_NIGHT” or CLOUD_ACCOUNT=“prod-west-2”.

In accordance with certain embodiments, TIME-STAMP 1118 records the RFC 3339 UTC time, down to the millisecond, at which the mapping engine finalized the vector, while SIGNATURE/HASH 1120 houses an HMAC-SHA-512 digest signed by the platform's hardware-security-module root key. In accordance with certain embodiments, the signature covers every preceding byte in the record so even a single-bit alteration breaks verification when the ledger appends the vector. By encoding change provenance, asset identity, jurisdictional scope, risk metrics, execution guidance, and cryptographic protections in a single, immutable record, FIG. 11 demonstrates how the platform supplies the reflex logic core with all context needed for deterministic control selection while furnishing regulators with end-to-end traceability.

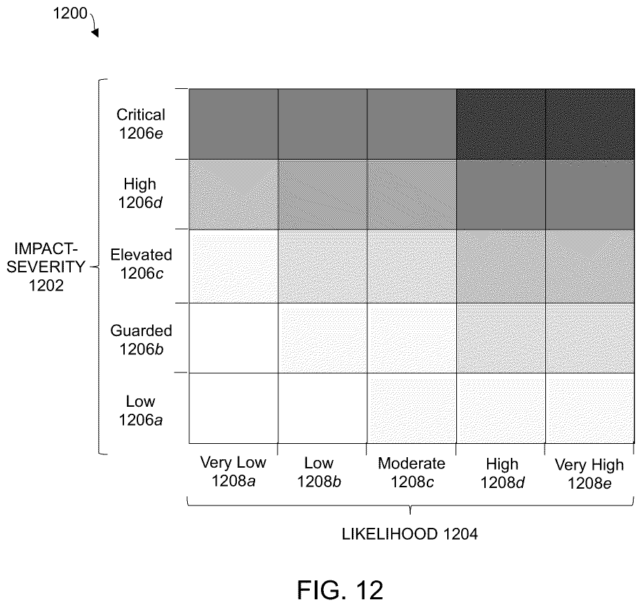

Referring now to FIG. 12, a five-by-five matrix that classifies risk weight by plotting impact severity against likelihood and shading cells from LOW to CRITICAL is shown. In accordance with certain aspects of the present disclosure, a risk-weight classification chart 1200 appears as a square, five-by-five matrix whose vertical axis 1202 plots impact-severity from “Low” at the bottom edge to “Critical” at the top, and whose horizontal axis 1204 plots likelihood from “Very Low” at the left margin to “Very High” at the right. The severity tick labels 1206a through 1206e occupy the leftmost margin in ascending order (i.e., Low, Guarded, Elevated, High, and Critical) while likelihood tick labels 1208a through 1208e run along the lower margin (i.e., Very Low, Low, Moderate, High, and Very High) so that every cell represents a unique pairing of severity and likelihood values. Within the grid, shading density increases monotonically from the lower-left corner toward the upper-right corner. Unshaded cells denote LOW risk, light shaded cells denote GUARDED risk, medium shaded cells denote ELEVATED risk, dark shaded cells denote HIGH risk, and the darkest shaded cells denote CRITICAL risk. Each cell therefore conveys a pre-calculated risk class that downstream modules can map directly to suppression thresholds, escalation policies, or automated control templates without recomputing raw severities or probabilities. By presenting impact and likelihood on orthogonal axes, FIG. 12 supplies the reflex-score evaluator with a deterministic lookup surface. In accordance with certain aspects of the present disclosure, the evaluator locates the cell whose row corresponds to the incoming impact-severity score and whose column corresponds to the incoming likelihood score, then adopts the shading-defined risk class as the base policy for threshold selection.

In accordance with certain aspects of the present disclosure, the platform further comprises a time-based risk decay engine configured to modulate compliance-risk values as a function of elapsed time. In accordance with certain embodiments, the time-based risk decay engine executes a formal RISK_DECAY_MODEL, a parametric function ƒ (VIOLATION_AGE, SEVERITY_ SCORE, COMPLIANCE_ EFFORT_ SCORE, DECISION_ LATENCY_ INDEX) , that computes a continuously updated risk magnitude for every unresolved delta object. In accordance with certain embodiments, VIOLATION_AGE represents the wall-clock duration since the underlying policy change or violation occurred, SEVERITY_SCORE is the initial impact value assigned by the risk-weighting module, COMPLIANCE_EFFORT_SCORE credits any mitigating actions already taken, and DECISION_LATENCY_INDEX captures the system's or an operator's response lag. The model outputs a scalar PROJECTED_ESCALATION_COST that grows when remedial action is delayed and decays when effective mitigation lowers residual exposure.

At runtime, the time-based risk decay engine streams the PROJECTED_ESCALATION_ COST into the reflex-score evaluator alongside the static impact-severity and likelihood metrics that originate from the risk-weighting matrix of FIG. 12. The reflex-score evaluator therefore derives an augmented reflex score that reflects not only intrinsic severity and probability but also the temporal cost of inaction. In accordance with certain embodiments, when the composite score exceeds a jurisdiction-specific threshold stored in configuration and threshold store 516 (as shown in FIG. 5), action decider 510 (as shown in FIG. 5) triggers orchestration even if the original static risk would have been suppressible. Conversely, as mitigation steps accumulate, COMPLIANCE_ EFFORT_SCORE rises, causing the decay model to lower PROJECTED_ESCALATION_COST and, by extension, the reflex score, thereby allowing the same decision logic to deactivate previously scheduled controls once risk has genuinely abated.

In certain embodiments, the time-based risk decay engine maintains a micro-service that subscribes to the audit ledger's event stream and recalculates PROJECTED_ ESCALATION_ COST at deterministic intervals (e.g., every 15 minutes). Each recalculation is appended to the ledger with a monotonic sequence number, ensuring an immutable provenance trail that auditors can replay to verify why a given control was executed, escalated, or cancelled at a particular point in time. Because the time-based risk decay engine feeds its decay-adjusted outputs back into the same causal pipeline that governs reflex decisions, the platform attains a closed feedback loop in which temporal risk dynamics directly inform automated enforcement actions.

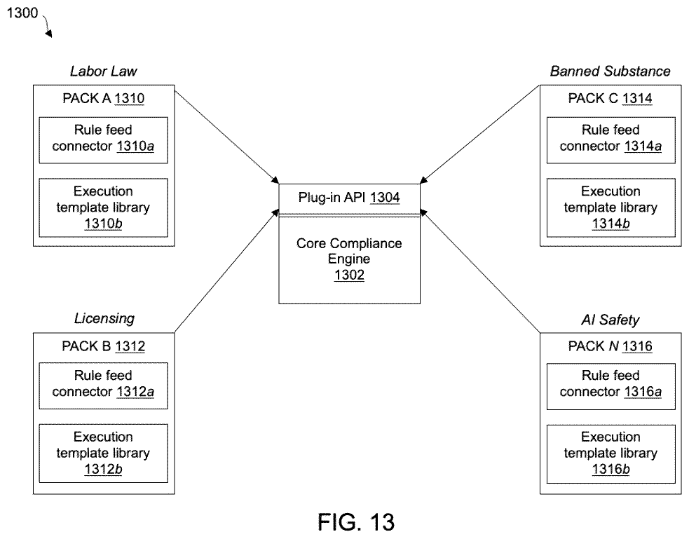

Referring now to FIG. 13, a block diagram 1300 illustrating modular reflex-pack plug-ins that dock into a core compliance engine through a standardized plug-in API is shown. In accordance with certain aspects of the present disclosure, block diagram 1300 illustrates the modular plug-in architecture that enables the automated policy-intervention platform to ingest new regulatory verticals without recompiling or redeploying core logic. In accordance with certain aspects of the present disclosure, the automated policy-intervention platform comprises platform 100 as shown in FIG. 1. In accordance with certain embodiments, a centrally positioned rectangle labeled Core Compliance Engine 1302 encloses the ingestion interface, delta-detection engine, contextual-mapping engine, reflex logic core, orchestration module, and audit ledger previously described with respect to FIGS. 1-6. As shown in FIG. 13, a Plug-in API 1302 represents a versioned, gRPC-secured interface that exposes one or more idempotent methods (e.g., RegisterRuleFeed( ), RegisterTemplate( ), DeregisterPack( ), and QueryPackStatus( )), thereby insulating Core Compliance Engine 1302 from direct dependencies on domain-specific rules or execution templates.

In accordance with certain aspects of the present disclosure, the automated policy-intervention platform may comprise a plurality of plug-in modules Pack A 1310, Pack B 1312, Pack C 1314, and Pack N 1316. As shown in FIG. 13, Pack A 1310 is associated with a “Labor Law” plug-in. In accordance with certain embodiments, Pack A 1310 comprises a rule feed connector 1310a that polls state and federal labor-department APIs and an Execution Template Library 1310b that hosts YAML snippets for payroll-rate updates, retroactive wage adjustments, and overtime recalculations. In accordance with certain embodiments, Pack B 1312 is associated with a “Licensing” plugin (e.g., medical licensing). In accordance with certain embodiments, Pack B 1312 comprises a rule feed connector 1312a for state medical-board bulletins and template library 1312b for privilege-suspension commands and credential-renewal workflows. In accordance with certain embodiments, Pack C 1314 is associated with a “Banned Substance” plug-in. In accordance with certain embodiments, Pack C 1314 comprises a rules feed connector 1314a that polls, for example, WADA and league feeds, and stores eligibility-revocation templates in library 1314b. In accordance with certain embodiments, Pack N 1316 is associated with a “AI Safety” plug-in. In accordance with certain embodiments, Pack N 1316 comprises a rule feed connector 1316a for large-language-model policy updates and library 1316b for model-weight quarantine and prompt-filter deployments.

As shown in FIG. 13, single-headed solid arrows extend from the right edge of each pack into plug-in API 1302. In accordance with certain aspects of the present disclosure, on initialization, each pack calls plug-in API 1302 to upload its rule-feed endpoint definitions, schema validators, execution templates, and pack-version metadata. In accordance with certain aspects of the present disclosure, the plug-ins interact solely through the published interface and never modify internal engine code.

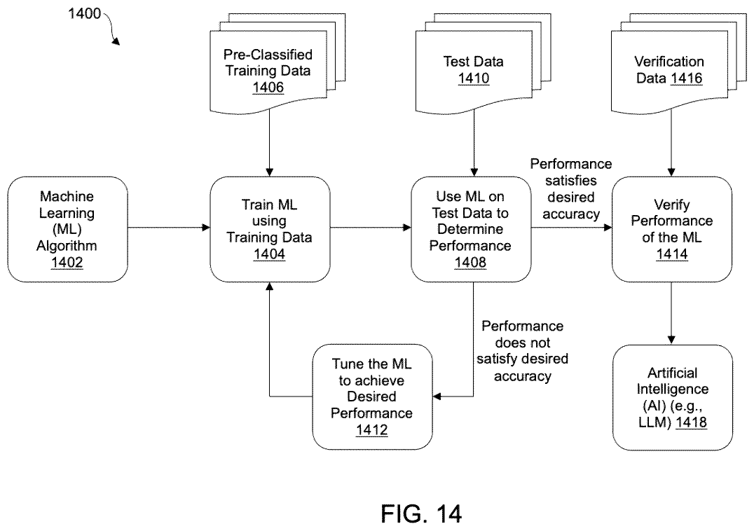

FIG. 14 is a flowchart of a process 1400 to train a machine learning algorithm, according to some implementations. For example, the process 1400 may be performed during pre-training or other training described herein. The operations in process 1400 may be performed in the order presented, in a different order, or simultaneously. Further, in some exemplary embodiments, some of the operations may be omitted, added, modified, skipped, or the like without departing from the scope of the invention.

At 1402, a machine learning algorithm (e.g., software code) may be created by one or more software designers. For example, the LLMs 130 may be created by software designers. At 1404, the machine learning algorithm may be trained using pre-classified training data 1406. For example, the training data 1406 may have been pre-classified by humans, by machine learning, or a combination of both. After the machine learning has been trained using the pre-classified training data 1406, the machine learning may be tested, at 1408, using test data 1410 to determine a performance metric of the machine learning. The performance metric may include, for example, precision, recall, Frechet Inception Distance (FID), or a more complex performance metric. For example, in the case of a classifier, the accuracy of the classification may be determined using the test data 1410.

If the performance metric of the machine learning does not satisfy a desired measurement (e.g., 95%, 98%, 99% in the case of accuracy), at 1408, then the machine learning code may be tuned, at 1412, to achieve the desired performance measurement. For example, at 1412, the software designers may modify the machine learning software code to improve the performance of the machine learning algorithm. After the machine learning has been tuned, at 1412, the machine learning may be retrained, at 1404, using the pre-classified training data 1406. In this way, 1404, 1408, 1412 may be repeated until the performance of the machine learning is able to satisfy the desired performance metric. For example, in the case of a classifier, the classifier may be tuned to be able to classify the test data 1410 with the desired accuracy.

After determining, at 1408, that the performance of the machine learning satisfies the desired performance metric, the process may proceed to 1414, where verification data 1416 may be used to verify the performance of the machine learning. After the performance of the machine learning is verified, at 1414, the machine learning 1402, which has been trained to provide a particular level of performance may be used as an artificial intelligence (AI) 1418, such as the LLM 130.

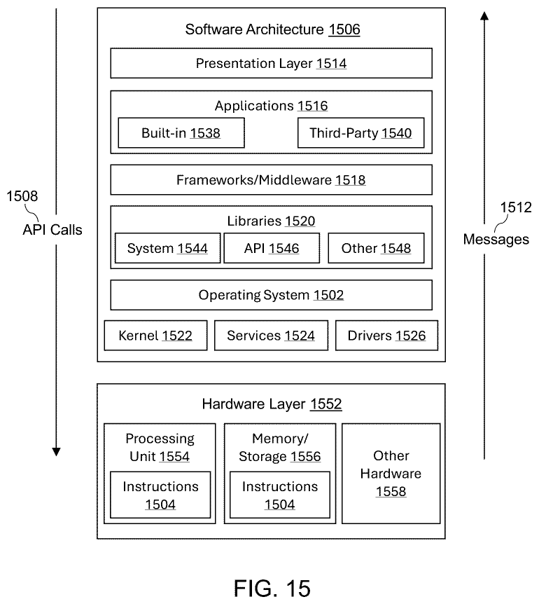

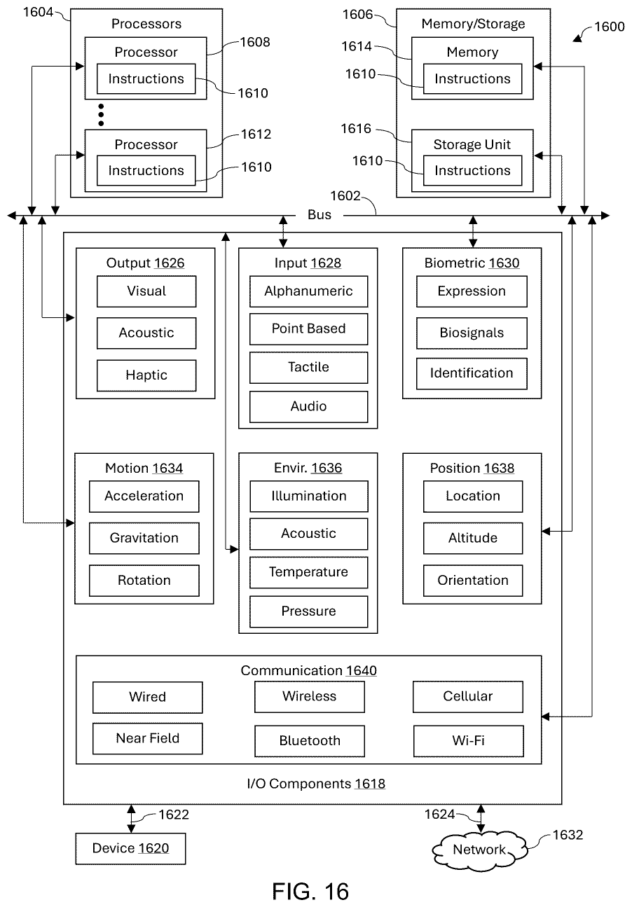

FIG. 15 is a block diagram illustrating an exemplary software architecture 1506, which may be used in conjunction with various hardware architectures herein described. FIG. 15 is a non-limiting example of a software architecture, and it will be appreciated that many other architectures may be implemented to facilitate the functionality described herein. The software architecture 1506 may execute on hardware such as machine 1600 of FIG. 16 that includes, among other things, processors 1604, memory 1614, and I/O components 1618. A representative hardware layer 1552 is illustrated and can represent, for example, the machine 1600 of FIG. 16. The representative hardware layer 1552 includes a processing unit 1554 having associated executable instructions 1504. Executable instructions 1504 represent the executable instructions of the software architecture 1506, including implementation of the methods, components and so forth described herein. The hardware layer 1552 also includes memory or storage modules memory/storage 1556, which also have executable instructions 1504. The hardware layer 1552 may also comprise other hardware 1558.

As used herein, the term “component” may refer to a device, physical entity or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions.

Components may constitute either software components (e.g., code embodied on a machine-readable medium) or hardware components. A “hardware component” is a tangible unit capable of performing certain operations and may be configured or arranged in a certain physical manner. In various exemplary embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations.

A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a processor or other programmable processor. Once configured by such software, hardware components become specific machines (or specific components of a machine) uniquely tailored to perform the configured functions and are no longer processors. It will be appreciated that the decision to implement a hardware component mechanically, in dedicated and permanently configured circuitry, or in temporarily configured circuitry (e.g., configured by software) may be driven by cost and time considerations.

A processor may be, or in include, any circuit, circuitry, or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously. The processor as used herein may be a hardware component, which is in at least one of the devices, systems, servers and the like. The processor may include multiple cores and may be spread across multiple devices. The processor includes circuitry to execute instructions relating to the methods and structures described herein for determining relationships and outputting relationship data that is used by various device and their users.

Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a processor configured by software to become a special-purpose processor, the processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access.

For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components.

Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some exemplary embodiments, the processors or processor-implemented components may be located in a single geographic location (e.g., within a home environment, an office environment, or a server farm). In other exemplary embodiments, the processors or processor-implemented components may be distributed across a number of geographic locations.

In the exemplary architecture of FIG. 15, the software architecture 1506 may be conceptualized as a stack of layers where each layer provides particular functionality. For example, the software architecture 1506 may include layers such as an operating system 1502, libraries 1520, applications 1516 and a presentation layer 1514. Operationally, the applications 1516 or other components within the layers may invoke application programming interface (API) API calls 1508 through the software stack and receive messages 1512 in response to the API calls 1508. The layers illustrated are representative in nature and not all software architectures have all layers. For example, some mobile or special purpose operating systems may not provide a frameworks/middleware 1518, while others may provide such a layer. Other software architectures may include additional or different layers.

The operating system 1502 may manage hardware resources and provide common services. The operating system 1502 may include, for example, a kernel 1522, services 1524 and drivers 1526. The kernel 1522 may act as an abstraction layer between the hardware and the other software layers. For example, the kernel 1522 may be responsible for memory management, processor management (e.g., scheduling), component management, networking, security settings, and so on. The services 1524 may provide other common services for the other software layers. The drivers 1526 are responsible for controlling or interfacing with the underlying hardware. For instance, the drivers 1526 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1520 provide a common infrastructure that is used by the applications 1516 or other components or layers. The libraries 1520 provide functionality that allows other software components to perform tasks in an easier fashion than to interface directly with the underlying operating system 1502 functionality (e.g., kernel 1522, services 1524 or drivers 1526). The libraries 1520 may include system libraries 1544 (e.g., C standard library) that may provide functions such as memory allocation functions, string manipulation functions, mathematical functions, and the like. In addition, the libraries 1520 may include API libraries 1546 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1520 may also include a wide variety of other libraries 1548 to provide many other APIs to the applications 1516 and other software components/modules.

The frameworks/middleware 1518 (also sometimes referred to as middleware) provide a higher-level common infrastructure that may be used by the applications 1516 or other software components/modules. For example, the frameworks/middleware 1518 may provide various graphic user interface (GUI) functions, high-level resource management, high-level location services, and so forth. The frameworks/middleware 1518 may provide a broad spectrum of other APIs that may be utilized by the applications 1516 or other software components/modules, some of which may be specific to a particular operating system 1502 or platform. The applications 1516 include built-in applications 1538 or third-party applications 1540. The third-party applications 1540 may invoke the API calls 1508 provided by the operating system 1502 to facilitate functionality described herein.

The applications 1516 may use built in operating system functions (e.g., kernel 1522, services 1524 or drivers 1526), libraries 1520, and frameworks/middleware 1518 to create user interfaces to interact with users of the system. Alternatively, or additionally, in some systems interactions with a user may occur through a presentation layer, such as presentation layer 1514. In these systems, the application/component “logic” can be separated from the aspects of the application/component that interact with a user.

FIG. 16 is a block diagram illustrating components (also referred to herein as “modules”) of a machine 1600, according to some exemplary embodiments, able to read instructions from a machine-readable medium (e.g., a machine-readable storage medium) and perform any one or more of the methodologies discussed herein. Specifically, FIG. 16 shows a diagrammatic representation of the machine 1600 in the example form of a computer system, within which instructions 1610 (e.g., software, a program, an application, an applet, an app, or other executable code) for causing the machine 1600 to perform any one or more of the methodologies discussed herein may be executed. As such, the instructions 1610 may be used to implement modules or components described herein. The instructions 1610 transform the non-programmed machine 1600 into a particular machine 1600 programmed to carry out the described and illustrated functions in the manner described. In alternative embodiments, the machine 1600 operates as a standalone device or may be coupled (e.g., networked) to other machines. In a networked deployment, the machine 1600 may operate in the capacity of a server machine or a client machine in a server-client network environment, or as a peer machine in a peer-to-peer (or distributed) network environment. The machine 1600 may comprise, but not be limited to, a server computer, a client computer, a personal computer (PC), a laptop computer, a network router, a network switch, a network bridge, or any machine capable of executing the instructions 1610, sequentially or otherwise, that specify actions to be taken by machine 1600. Further, while only a single machine 1600 is illustrated, the term “machine” shall also be taken to include a collection of machines that individually or jointly execute the instructions 1610 to perform any one or more of the methodologies discussed herein.

The machine 1600 may include processors 1604, memory memory/storage 1606, and I/O components 1618, which may be configured to communicate with each other such as via a bus 1602. The memory/storage 1606 may include a memory 1614, such as a main memory, or other memory storage, and a storage unit 1616, both accessible to the processors 1604 such as via the bus 1602. The storage unit 1616 and memory 1614 store the instructions 1610 embodying any one or more of the methodologies or functions described herein. The instructions 1610 may also reside, completely or partially, within the memory 1614, within the storage unit 1616, within at least one of the processors 1604 (e.g., within the processor's cache memory), or any suitable combination thereof, during execution thereof by the machine 1600. Accordingly, the memory 1614, the storage unit 1616, and the memory of processors 1604 are examples of machine-readable media.

As used herein, the term “machine-readable medium,” “computer-readable medium,” or the like may refer to any component, device or other tangible media able to store instructions and data temporarily or permanently. Examples of such media may include, but is not limited to, random-access memory (RAM), read-only memory (ROM), buffer memory, flash memory, optical media, magnetic media, cache memory, other types of storage (e.g., Erasable Programmable Read-Only Memory (EEPROM)) or any suitable combination thereof. The term “machine-readable medium” should be taken to include a single medium or multiple media (e.g., a centralized or distributed database, or associated caches and servers) able to store instructions. The term “machine-readable medium” may also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” may refer to a single storage apparatus or device, as well as “cloud-based” storage systems or storage networks that include multiple storage apparatus or devices. The term “machine-readable medium” excludes signals per se.

The I/O components 1618 may include a wide variety of components to provide a user interface for receiving input, providing output, producing output, transmitting information, exchanging information, capturing measurements, and so on. The specific I/O components 1618 that are included in the user interface of a particular machine 1600 will depend on the type of machine. It will be appreciated that the I/O components 1618 may include many other components that are not shown in FIG. 16. The I/O components 1618 are grouped according to functionality merely for simplifying the following discussion and the grouping is in no way limiting. In various exemplary embodiments, the I/O components 1618 may include output components 1626 and input components 1628. The output components 1626 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 1628 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location or force of touches or touch gestures, or other tactile input components), audio input components (e.g., a microphone), and the like. The input components 1628 may also include one or more image-capturing devices, such as a digital camera for generating digital images or video.

In further exemplary embodiments, the I/O components 1618 may include biometric components 1630, motion components 1634, environmental environment components 1636, or position components 1638, as well as a wide array of other components. One or more of such components (or portions thereof) may collectively be referred to herein as a “sensor component” or “sensor” for collecting various data related to the machine 1600, the environment of the machine 1600, a user of the machine 1600, or a combinations thereof.

Communication may be implemented using a wide variety of technologies. The I/O components 1618 may include communication components 1640 operable to couple the machine 1600 to a network 1632 or devices 1620 via coupling 1622 and coupling 1624 respectively. For example, the communication components 1640 may include a network interface component or other suitable device to interface with the network 1632. In further examples, communication components 1640 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1620 may be another machine or any of a wide variety of peripheral devices (e.g., a peripheral device coupled via a Universal Serial Bus (USB)). Moreover, the communication components 1640 may detect identifiers or include components operable to detect identifiers.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general-purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. All publications mentioned herein are incorporated herein by reference to disclose and describe the methods and/or materials in connection with which the publications are cited.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

Any publications discussed herein are provided solely for their disclosure prior to the filing date of the present application. Nothing herein is to be construed as an admission that the present invention is not entitled to antedate such publication by virtue of prior invention. Further, the dates of publication provided may differ from the actual publication dates which may need to be independently confirmed.

Where a phrase similar to “at least one of A, B, or C,” “at least one of A, B, and C,” “one or more A, B, or C,” or “one or more of A, B, and C” is used, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that phases of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While certain exemplary embodiments have been described and shown in the accompanying drawings, it is to be understood that such embodiments are merely illustrative of, and not restrictive on, the broad invention, and that this invention is not limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A computer-implemented method for automated intervention of policy changes, the method comprising:
receiving, by one or more processors, a first version of a policy document and a second version of the policy document;
executing, by a delta-detection engine, instructions that compare the first version of the policy document and the second version of the policy document to identify at least one linguistic difference and, in response, generate a delta object based on the at least one linguistic difference;
inputting the delta object to a mapping engine to determine one or more affected target and to produce at least one context vector configured to describe an operational impact of the at least one linguistic difference;
providing the delta object and the at least one context vector to a reflex logic core executable by a large language model inference service,
wherein the reflex logic core is configured to specify at least one remedial control action, a condition under which the at least one remedial control action is to be executed, and an identity of an actor or system authorized to execute the at least one remedial control action;
automatically executing, by an orchestration module, the at least one remedial control action on the one or more affected target by issuing at least one programmatic call to an external system interface; and
recording, in an audit ledger, the delta object, the at least one context vector, the at least one remedial control action, and a reasoning trace produced by the reflex logic core.

2. The computer-implemented method of claim 1 wherein generating the delta object further comprises assigning a risk-weight value to the delta object based on at least one of an impact-severity metric and a likelihood metric.

3. The computer-implemented method of claim 1 wherein the reflex logic core computes a reflex score for the delta object, compares the reflex score to a predefined threshold, and suppresses execution of the at least one remedial control action when the reflex score is below the predefined threshold.

4. The computer-implemented method of claim 1 wherein the reflex logic core comprises a chain-of-thought prompt stack executable by the large language model inference service.

5. The computer-implemented method of claim 1 wherein the at least one context vector comprises a mapping between an originating policy citation and a unique identifier of the one or more affected target selected from the group consisting of: a microservice, a containerized workload, a database schema, and a user role.

6. The computer-implemented method of claim 1 wherein the first version of the policy document and the second version of the policy document are received from an external policy source feed selected from the group consisting of: a governmental regulation repository, a contractual document-management system, a standards-body publication portal, and an artificial intelligence safety policy registry.

7. The computer-implemented method of claim 1 further comprising selecting, based on the at least one context vector, a domain-specific execution pack that supplies a predefined remedial control action template to the orchestration module.

8. The computer-implemented method of claim 1 further comprising rendering, in a user interface, a reflex graph that visually links the delta object, the at least one context vector, and the executed at least one remedial control action.

9. The computer-implemented method of claim 1 wherein the orchestration module is configured to monitor, in real time, a status returned from the external system interface.

10. The computer-implemented method of claim 9 wherein, upon detecting a failure status from the external system interface, the orchestration module is configured to automatically generate and execute a fallback remedial control action and record the fallback remedial control action in the audit ledger.

11. An automated policy intervention system comprising:
an ingestion interface configured to receive a first version of a policy document and a second version of the policy document;
a delta-detection engine operatively coupled to the ingestion interface,
wherein the delta-detection engine is configured to compare the first version of the policy document and the second version of the policy document to identify at least one linguistic difference and, in response, to generate a delta object based on the at least one linguistic difference;
a mapping engine configured to determine one or more affected target associated with the delta object and to produce at least one context vector configured to describe an operational impact of the at least one linguistic difference;
a reflex logic core comprising a prompt stack stored in a non-transitory memory and a large language model inference service,
wherein the reflex logic core is configured to specify at least one remedial control action, a condition under which the at least one remedial control action is to be executed, and an identity of an actor or system authorized to execute the at least one remedial control action;
an orchestration module communicatively coupled to the reflex logic core,
wherein the orchestration module is configured to execute the at least one remedial control action on the one or more affected target by issuing at least one programmatic call to an external system interface; and
an audit ledger configured to record the delta object, the at least one context vector, an identifier of the executed at least one remedial control action, and a reasoning trace produced by the reflex logic core.

12. The system of claim 11 further comprising a risk-weighting module configured to assign an impact-severity value to the delta object and store the impact-severity value in association with the delta object in the audit ledger.

13. The system of claim 11 wherein the reflex logic core is further configured to compute a reflex score for the delta object, compare the reflex score with a predefined threshold, and suppress execution of the at least one remedial control action when the reflex score is below the predefined threshold.

14. The system of claim 11 wherein the prompt stack comprises a chain-of-thought prompt stack executable by the large language model inference service.

15. The system of claim 11 wherein each context vector in the at least one context vector comprises a mapping between an originating policy citation and a unique identifier of the one or more affected target selected from the group consisting of: a microservice, a containerized workload, a database schema, and a user role.

16. The system of claim 11 wherein the ingestion interface is configured to receive the first version of the policy document and the second version of the policy document from an external policy-source feed selected from the group consisting of: a governmental regulation repository, a contractual document-management system, a standards-body publication portal, and an artificial intelligence safety policy registry.

17. The system of claim 11 further comprising a user-interface module configured to render, in a graphical display, a reflex graph that visually links the delta object, the at least one context vector, and the executed at least one remedial control action.

18. The system of claim 11 wherein the orchestration module is configured to monitor, in real time, a status returned from the external system interface.

19. The system of claim 18 wherein, upon detecting a failure status from the external system interface, the orchestration module is configured to automatically generate and execute a fallback remedial control action and record the fallback action in the audit ledger.

20. A non-transitory computer-readable storage medium encoded with instructions that, when executed by one or more processors of a computing system, cause the computing system to perform operations comprising:
receiving a first version of a policy document and a second version of the policy document;
comparing, via a delta-detection module, the first version of the policy document and the second version of the policy document to identify at least one linguistic difference and, in response, generating a structured delta object that characterizes the at least one linguistic difference;
mapping, via a contextual-mapping module, the structured delta object to determine one or more affected target and to produce at least one context vector to describe an operational impact of the at least one linguistic difference;
executing, by a reflex logic core, a large language model inference service to receive the structured delta object and the at least one context vector,
wherein the reflex logic core is configured to specify at least one remedial control action, a condition under which the at least one remedial control action is to be executed, and an identity of an actor or a system authorized to execute the at least one remedial control action;
invoking, via an orchestration module, the at least one remedial control action on the one or more affected target by issuing at least one programmatic call to an external system interface; and
recording, in an audit ledger, the structured delta object, the at least one context vector, the at least one remedial control action, and a reasoning trace produced by the reflex logic core.
